(19) United States
(12) Patent Application Publication
(10) Pub. No.: US 2026/0225417 A1
(43) Pub. Date: Aug. 6, 2026

(54) A WHEELED WORK VEHICLE AND A METHOD FOR ADJUSTING TRACKING AND CAMBER OF WHEELS OF A WORK VEHICLE

(71) Applicant: MULTIHOG R & D LIMITED, Dundalk, County Louth (IE)

(72) Inventors: James McADAM, Carlingford (IE); Samuel HAMPSHIRE, Drogheda (IE); Gerard McHUGH, Carickmacross (IE); Cormac BARRY, Dundalk (IE)

(73) Assignee: MULTIHOG R & D LIMITED, Dundalk, County Louth (IE)

(21) Appl. No.: 19/151,889

(22) PCT Filed: Feb. 2, 2024
(86) PCT No.: PCT/IE2024/000002

§ 371 Date: Jul. 29, 2025

(30) Foreign Application Priority Data
Feb. 2, 2023 (IE) S2023/0018

(51) Int. Cl. B60G 3/14; B60K 7/00; B60T 1/06; B62D 17/00

(52) U.S. Cl. CPC B60G 3/14; B60K 7/0007; B60T 1/067; B62D 17/00; B60G 2200/46; B60G 2200/462; B60Y 2200/417

(57) ABSTRACT

A wheeled work vehicle (1) comprising a fon/vard part (3) and a rearward part (5) pivotally coupled together for steering thereof supported on pairs of rearward and fon/vard ground engaging wheels (34, 87) carried on respective suspension arms (27, 88). The suspension arms (27, 88) are pivotally coupled to chassis (12, 14). An electrically powered motor (32, 95) mounted on the second end (29) of each suspension arm (27, 88) extends into a wheel well (52) with a wheel rim (50) of the corresponding ground g engaging wheel (34, 87). The wheel rims (50) are secured to coupling plates (47) of the motors (32, 95). The axial length of each motor (32, 95) is such that substantially the entire motor fits within the wheel well (52). The tracking and camber of each ground engaging wheel (34, 87) is adjustable by engaging appropriate ones of a plurality of selectable adjustment elements (70) in secondary bores (80) in inner and outer mounting brackets (58, 59) on which the suspension arms (27, 88) are pivotal. Each adjustment element (70) comprises an engagement member (74) defining an engagement member central axis (81). A pivot shaft engagement bore (80) extends through the engagement member (74) for engaging a pivot A shaft (82) on which the corresponding suspension arm (27, 88) is pivotal. The engagement bore central axis (82) is spaced apart from the engagement member central axis (81) different distances in the respective adjustment elements (70) for adjusting the tracking and camber of the corresponding ground engaging wheel (34, 87).

The present invention relates to a wheeled work vehicle, and the invention also relates to a method for adjusting the tracking and camber of ground engaging wheels of a wheeled work vehicle, and the invention also relates to adjustment elements for use in adjusting the tracking of the ground engaging wheels of a wheeled work vehicle.

Wheeled work vehicles are well known, and may be of the type comprising a single chassis, which is supported on a pair of forward steerable ground engaging wheels, and a pair of rearward non-steerable ground engaging wheels. Such wheeled work vehicles may also be of the type comprising a forward part and a rearward part pivotally coupled together about a substantially vertically extending pivot axis. The forward and rearward parts are typically supported on respective pairs of non-steerable ground engaging wheels. Steering of such two-part work vehicles is achieved by pivoting the forward and rearward parts about the vertically extending pivot axis relative to each other. In general, such two-part wheeled work vehicles comprise a pair of hydraulic rams located on respective opposite sides of the vertical pivot axis and spaced apart therefrom. The hydraulic rams are connected between the forward and rearward parts to effect steering of the wheeled work vehicle.

In general, such single axis wheeled work vehicles and two-part wheeled work vehicles comprise a relatively narrow wheel base, which in general, is narrower than a standard automobile wheel base. This, thus, results in the cab of such wheeled work vehicles being relatively narrow, and also and more importantly results in a reduction in the available space between the rearward ground engaging wheels for components, such as, an internal combustion engine for producing a hydraulic power supply, components, for example, a collection container for collecting litter and debris drawn by vacuum from roadways and other areas in cases where the wheeled work vehicle is provided as a road sweeping and cleaning vehicle, as well as batteries which are required to power electric versions of such wheeled work vehicles.

In some cases, the non-steerable ground engaging wheels of such wheeled work vehicles are carried on suspension arms, which may be trailing suspension arms or leading suspension arms, and such suspension arms are generally pivotally coupled to the chassis, in the case of a single chassis wheeled work vehicle, or to forward and rearward chassis of two-part work vehicles. In general, the driven ground engaging wheels of such wheeled work vehicles may be driven by corresponding motors, either hydraulic powered or electrically powered, or the driven ground engaging wheels may be driven from a single drive through a differential drive unit. However, in cases where the ground engaging wheels are being driven by respective hydraulic motors or electrically powered motors, such motors, be they hydraulic or electric motors tend to be rather large, and due to their size are, in general, mounted on the inner side of the corresponding suspension arm with the corresponding ground engaging wheel mounted on the outer side of the suspension arm. A drive shaft extending through the suspension arm transmits drive from the hydraulically or electrically powered motor to a wheel hub or wheel coupling plate to which the corresponding ground engaging wheel is releasably secured. The provision of such motors on the inner side of such suspension arms, further reduces the available space. This is undesirable.

A further problem experienced with such wheeled work vehicles is that in general, adjusting the tracking and the camber of such wheeled work vehicles can be a relatively difficult and tedious task.

Accordingly, there is a need for a wheeled work vehicle, which addresses at least one of these problems.

The present invention is directed towards providing such a wheel worked vehicle, and the invention is also directed towards providing a method for adjusting the tracking and/or camber of such a wheeled work vehicle, and further, the invention is directed towards providing an adjustment element for use in adjustment of the tracking and/or camber of such a wheeled work vehicle.

According to the invention there is provided a wheeled work vehicle comprising a chassis supported on a pair of spaced apart forward ground engaging wheels and a pair of spaced apart rearward ground engaging wheels with the rearward ground engaging wheels spaced apart rearwardly from the forward ground engaging wheels, at least the pair of the forward ground engaging wheels or the pair of the rearward ground engaging wheels being carried on respective suspension arms, each suspension arm extending from a first end to a second end, and being pivotally coupled adjacent the first end thereof to the chassis about a corresponding main transverse pivot axis extending substantially transversely relative to the normal forward direction of travel of the work vehicle, and carrying a corresponding electrically powered motor adjacent the second end thereof for driving the corresponding ground engaging wheel, each motor defining a rotational drive axis about which drive is delivered by the motor and extending sidewardly outwardly from the corresponding suspension arm with the drive axis of the motor extending transversely relative to the normal forward direction of travel of the work vehicle, and each motor defining an outer transverse cross-sectional area transversely of the drive axis thereof less than the transverse cross-sectional area of the well of a wheel rim of the corresponding ground engaging wheel, so that the motor fits substantially within the well of the wheel rim of the corresponding ground engaging wheel.

In one embodiment of the invention each motor comprises a housing defining the outer transverse cross-sectional area of the motor secured to the corresponding suspension arm, and a coupling element rotatable in the housing and rotatably driven by the motor about the drive axis thereof, preferably, the coupling element is adapted for releasable coupling of the wheel rim of the corresponding ground engaging wheel thereto.

In another embodiment of the invention the coupling element of each motor is rotatably mounted in the housing thereof, and is driven by components of the motor located in the housing of the motor.

In one embodiment of the invention each motor comprises a drive means rotatably mounted in the housing thereof about the drive axis, the drive means being driven by the motor, and the coupling element is mounted fast on the drive means and is driven by the drive means.

Preferably, a braking system is located within the housing of each motor cooperable directly or indirectly with the drive means or the coupling element for braking thereof. Advantageously, the braking system cooperates with the drive means for braking thereof.

In one embodiment of the invention the braking system comprises a dynamic braking means for slowing the rotational speed delivered by the drive means of the motor. Preferably, the braking system comprises a parking braking means for preventing rotation of the drive means.

Preferably, the dynamic braking means comprises the parking braking means.

In one embodiment of the invention the dynamic braking means comprises a shoe brake.

Preferably, the shoe brake comprises a pair of brake shoes acting on a drum mounted fast on the drive means.

Advantageously, the brake shoes act on an inner surface of the drum.

In an alternative embodiment of the invention the braking system comprises a disc brake.

In one embodiment of the invention a speed reduction means or a speed increasing means is located within the housing of each motor to reduce or increase the speed of the drive from the drive means to the coupling element of the corresponding electric motor.

In one embodiment of the invention the speed reduction means comprises a speed reduction gear train.

In another embodiment of the invention the speed increasing means comprises a step-up gear train.

In one embodiment of the invention the housing of each motor is of length along its drive axis so that the motor fits substantially entirely within the well of the wheel rim of the corresponding ground engaging wheel or a portion of the motor extends axially outwardly of the well of the wheel rim of the corresponding ground engaging wheel.

Preferably, the housing of each motor defines a securing location at which the housing is adapted for securing to the corresponding suspension arm, the securing location defined by the housing being axially spaced apart from the coupling element.

In one embodiment of the invention the securing location of the housing of each motor is located spaced apart axially from the coupling element. In one embodiment of the invention the securing location is located at one end of the motor opposite to the end at which the coupling element is located, and in another embodiment of the invention the securing location is located intermediate the coupling element and the opposite end of the motor.

In one embodiment of the invention the spacing between the securing location defined by the housing of each motor and the coupling element thereof is substantially equal to or greater than the depth of the well of the wheel rim of the corresponding ground engaging wheel.

In another embodiment of the invention a mounting element is located on the housing of each motor adjacent the securing location for securing the housing of the motor to the corresponding suspension arm.

Preferably, the coupling element of each motor comprises a central coupling plate.

Advantageously, the coupling element carries at least three threaded studs, or is provided with at least three threaded bores, the threaded studs or the threaded bores being equi-spaced apart angularly about the drive axis defined by the motor. Preferably, four threaded studs or threaded bores are provided on the coupling element.

In one embodiment of the invention the suspension arms of the rearward ground engaging wheels or the forward ground engaging wheels extends generally rearwardly from the corresponding main transverse pivot axis about which the suspension arm is pivotally coupled to the chassis.

Preferably, the suspension arms of the forward ground engaging wheels are pivotal independently of each other about the respective main transverse pivot axes thereof about which the suspension arms are pivotally coupled to the chassis.

Advantageously, the suspension arms of the rearward ground engaging wheels are pivotal independently of each other about the respective main transverse pivot axes thereof about which the suspension arms are pivotally coupled to the chassis.

In one embodiment of the invention the main transverse pivot axes of the suspension arms of the forward ground engaging wheels are substantially axially aligned with each other.

In another embodiment of the invention the main transverse pivot axes of the suspension arms of the rearward ground engaging wheels are substantially axially aligned with each other.

In one embodiment of the invention each suspension arm adjacent the first end thereof terminates in a pivot mounting member defining a main bore extending therethrough cooperable with a corresponding pivot shaft coupled to the chassis, the pivot shaft defining the corresponding main transverse pivot axis about which the suspension arm is pivotal.

In another embodiment of the invention the pivot shaft is carried on at least one mounting bracket mounted on the chassis.

In another embodiment of the invention the pivot shaft of each suspension arm is carried on a corresponding pair of the mounting brackets spaced apart transversely from each other, with the corresponding pivot shaft extending between the two mounting brackets.

Preferably, the pivot mounting member of each suspension arm is located between the corresponding pair of the mounting brackets.

In one embodiment of the invention each mounting bracket defines a secondary bore extending therethrough for accommodating the corresponding pivot shaft therein.

In another embodiment of the invention either one of or both of the secondary bore of at least one of the mounting brackets of the corresponding suspension arm, or the main bore extending through the pivot mounting member of the corresponding suspension arm is adapted for engaging one of a plurality of selectable adjustment elements, each adjustment element comprising an engagement member for engaging the corresponding one of the secondary bore of the at least one of the mounting brackets or the main bore in the pivot mounting member, the engagement member defining an engagement member central axis, and having an engagement bore extending therethrough for engaging the pivot shaft of the corresponding pivot mounting member, the engagement bore of each adjustment element defining an engagement bore central axis, the engagement bore central axis of each adjustment element defining the main transverse pivot axis about which the corresponding suspension arm is pivotal when the engagement member of the adjustment element is engaged in the secondary bore of the corresponding one of the mounting brackets, or the main bore of the pivot mounting member.

In another embodiment of the invention the engagement bore central axis of each adjustment element extends substantially parallel to the engagement member central axis of the engagement member thereof.

In another embodiment of the invention the engagement bore central axis coincides with the engagement member central axis of at least one of the adjustment elements adjacent the engagement bore thereof of the plurality of the adjustment elements.

In another embodiment of the invention the spacings between the engagement bore central axis and the engagement member central axis of two of the adjustment elements adjacent the engagement bore thereof are substantially identical to each other.

In a further embodiment of the invention the spacing between the engagement bore central axis and the engagement member central axis of at least one of the adjustment elements adjacent the engagement bore thereof is different to the spacing between the engagement bore central axis and the engagement member central axis of other ones of the adjustment elements adjacent the engagement bore thereof for adjusting one or both of the tracking (toe-in/toe-out) or the camber of the corresponding one of the ground engaging wheels.

Preferably, the spacings between the engagement bore central axis and the engagement member central axis of a plurality of the adjustment elements adjacent the engagement bores thereof progressively increase from one of the adjustment elements in which the engagement bore central axis coincides with or is closest to the engagement member central axis adjacent the engagement bore thereof to the adjustment element in which the spacing between the engagement bore central axis and the engagement member central axis adjacent the engagement bore thereof is greatest.

Advantageously, the spacings between the engagement bore central axis and the engagement member central axis of the plurality of the adjustment elements adjacent the engagement bore thereof progressively increase from one of the adjustment elements to the next one of the adjustment elements by a predefined incremental amount.

In one embodiment of the invention the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.25 mm to 3.00 mm.

Preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.5 mm to 2 mm.

Advantageously, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.75 mm to 1.5 mm.

Preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.9 mm to 1.25 mm.

Ideally, the predefined incremental amount, by which the spacing between the engagement bore central axis and the engagement member central axis of the plurality of the adjustment elements progressively increase from one of the adjustment elements to the next one of the adjustment elements is approximately 1 mm.

In one embodiment of the invention a keying means is provided for keying the adjustment elements relative to the secondary bore of each of the mounting brackets or the main bore extending through each of the pivot mounting members with the direction of the spacing of the engagement bore central axis from the engagement member central axis of the adjustment element adjacent the engagement bore thereof extending in at least one selectable predefined direction relative to the normal forward direction of travel of the work vehicle when inserted in the secondary bore of one of the mounting brackets or the main bore of one of the pivot mounting members.

In another embodiment of the invention one of the predefined directions comprises a forward direction relative to the normal forward direction of travel of the work vehicle to adjust the tracking of the corresponding one of the ground engaging wheels of the work vehicle.

In another embodiment of the invention one of the predefined directions comprises a rearward direction relative to the normal forward direction of travel of the work vehicle to adjust the tracking of the corresponding one of the ground engaging wheels of the work vehicle.

In another embodiment of the invention one of the predefined directions comprises an upward direction relative to the normal forward direction of travel of the work vehicle to adjust the camber of the corresponding one of the ground engaging wheels of the work vehicle.

In another embodiment of the invention one of the predefined directions comprises a downward direction relative to the normal forward direction of travel of the work vehicle to adjust the camber of the corresponding one of the ground engaging wheels of the work vehicle.

In one embodiment of the invention the keying means is configured to permit the engagement member of the adjustment elements to engage the secondary bore of the mounting brackets or the main bore of the pivot mounting members in at least one selectable predefined orientation with the direction of the spacing of the engagement bore central axis from the engagement member central axis adjacent the engagement bore thereof extending in at least a corresponding one of the predefined directions.

In another embodiment of the invention the keying means is configured to permit the engagement member of the adjustment elements to engage the secondary bore of the mounting brackets or the main bore of the pivot mounting members in at least two selectable predefined orientations with the direction of the spacing of the engagement bore central axis from the engagement member central axis adjacent the engagement bore thereof extending in at least two of the corresponding predefined directions.

In another embodiment of the invention the keying means is configured to permit the engagement member of the adjustment elements to engage the secondary bore of the mounting brackets or the main bore of the pivot mounting members in at least three selectable predefined orientations with the direction of the spacing of the engagement bore central axis from the engagement member central axis adjacent the engagement bore thereof extending in at least three of the corresponding predefined directions.

In another embodiment of the invention the keying means is configured to permit the engagement member of the adjustment elements to engage the secondary bore of the mounting brackets or the main bore of the pivot mounting members in four selectable predefined orientations with the direction of the spacing of the engagement bore central axis from the engagement member central axis adjacent the engagement bore thereof extending in the four corresponding predefined directions.

Preferably, the keying means comprises providing the outer periphery of the engagement member of the adjustment elements to engage the secondary bore of the mounting brackets or the main bore of the pivot mounting members.

Preferably, the keying means is provided by providing the outer periphery of the engagement member of the adjustment elements to be complementary to the secondary bore of the mounting brackets or the main bore of the pivot mounting members.

Advantageously, the outer periphery of the engagement member of the adjustment elements is of substantially square shape.

In one embodiment of the invention the engagement member of each one of the plurality of the adjustment elements defines a substantially square cross-section.

In one embodiment of the invention each adjustment element comprises an indicating means to indicate the direction of the spacing of the engagement bore central axis from the engagement member central axis. Preferably, the indicating means is configured to indicate the amount by which the engagement bore central axis is spaced apart from the engagement member central axis.

In one embodiment of the invention the engagement member of each one of the plurality of the adjustment elements is engageable with the secondary bore defined by the mounting brackets.

In another embodiment of the invention the secondary bore of each one of the mounting brackets of the pairs thereof are of similar cross-sectional shape.

In another embodiment of the invention the forward ground engaging wheels are carried on respective ones of the suspension arms.

In another embodiment of the invention the rearward ground engaging wheels are carried on respective ones of the suspension arms.

Preferably, the forward ground engaging wheels and the rearward ground engaging wheels are carried on respective ones of the suspension arms.

In one embodiment of the invention the chassis comprises a forward chassis, and a rearward chassis pivotally coupled to the forward chassis about a generally upwardly extending primary pivot axis about which the work vehicle is steerable. Preferably, the forward chassis is supported on the pair of spaced apart forward ground engaging wheels, and the rearward chassis is supported on the pair of spaced apart rearward ground engaging wheels.

In another embodiment of the invention the suspension arm of each one of the forward ground engaging wheels is pivotally connected to the forward chassis about the corresponding main transverse pivot axis. Preferably, the suspension arm of each one of the forward ground engaging wheels is pivotally connected to the forward chassis about the corresponding main transverse pivot axis by at least a corresponding one of the mounting brackets mounted on the forward chassis.

In one embodiment of the invention the suspension arm of each one of the rearward ground engaging wheels is pivotally connected to the rearward chassis about the corresponding main transverse pivot axis. Preferably, the suspension arm of each one of the rearward ground engaging wheels is pivotally connected to the rearward chassis about the corresponding main transverse pivot axis by at least a corresponding one of the mounting brackets mounted on the rearward chassis.

Preferably, the forward and rearward chassis comprise respective pairs of the suspension arms carrying corresponding ones of the motors adjacent the second ends thereof.

Additionally, the invention provides a wheeled work vehicle comprising a chassis supported on a pair of spaced apart forward ground engaging wheels and a pair of spaced apart rearward ground engaging wheels with the rearward ground engaging wheels spaced apart rearwardly from the forward ground engaging wheels, at least either the pair of the forward ground engaging wheels or the pair of the rearward ground engaging wheels being carried on respective suspension arms, each suspension arm extending from a first end to a second end, and carrying the corresponding ground engaging wheel adjacent the second end thereof, the first end of each suspension arm being pivotally coupled to the chassis about a corresponding main transverse pivot axis extending substantially transversely of the normal forward direction of travel of the work vehicle, the first end of each suspension arm terminating in a pivot mounting member defining a main bore extending therethrough for accommodating a pivot shaft therethrough defining the corresponding main transverse pivot axis about which the suspension arm is pivotal, the main pivot shaft being carried on at least one mounting bracket mounted on the chassis, the at least one mounting bracket defining a secondary bore extending therethrough, and a plurality of selectable adjustment elements, each adjustment element comprising an engagement member engageable with the secondary bore of the at least one mounting bracket or the main bore of the pivot mounting member and defining an engagement member central axis, and having an engagement bore extending therethrough engageable with the pivot shaft of the corresponding suspension arm and defining an engagement bore central axis, the engagement bore central axis defining the main transverse pivot axis about which the corresponding suspension arm is pivotal, the spacing between the engagement bore central axis and the engagement member central axis adjacent the engagement bore thereof of at least one of the adjustment elements being different to the spacing between the engagement bore central axis and the engagement member central axis adjacent the engagement bore thereof of other ones of the adjustment elements for adjusting one or both of the tracking (toe in/toe out) or the camber of the corresponding ground engaging wheel.

Preferably, a pair of spaced apart mounting brackets corresponding to each suspension arm are mounted on the chassis, and the pivot mounting member of the corresponding suspension arm is located between the mounting brackets.

In one embodiment of the invention the mounting brackets of each pair thereof comprise respective ones of the adjustment elements located in the secondary bores thereof, or the main bore defined by the pivot mounting member of each suspension arm comprises a pair of the adjustment elements located spaced apart therein, the orientation of the adjustment elements in the secondary bores of the pair of the mounting brackets, or the orientation of the adjustment elements in the main bore of the pivot mounting member being the same or different.

In another embodiment of the invention the spacings between the engagement bore central axis and the engagement member central axis of the adjustment elements in the secondary bores of the mounting brackets of each pair thereof, or in the main bore of the pivot mounting member are the same or different.

In one embodiment of the invention the chassis comprises a two-part chassis comprising a forward chassis and a rearward chassis, the forward chassis and the rearward chassis being pivotally coupled about a primary pivot axis for steering of the work vehicle.

In one embodiment of the invention the suspension arm of each one of the forward ground engaging wheels is pivotally connected to the forward chassis about the corresponding main transverse pivot axis. Preferably, the suspension arm of each one of the forward ground engaging wheels is pivotally connected to the forward chassis about the corresponding main transverse pivot axis by at least a corresponding one of the mounting brackets mounted on the forward chassis.

In another embodiment of the invention the suspension arm of each one of the rearward ground engaging wheels is pivotally connected to the rearward chassis about the corresponding main transverse pivot axis. Preferably, the suspension arm of each one of the rearward ground engaging wheels is pivotally connected to the rearward chassis about the corresponding main transverse pivot axis by at least a corresponding one of the mounting brackets mounted on the rearward chassis.

In another embodiment of the invention a pair of rams are coupled between the forward and rearward parts on respective opposite sides of the primary pivot axis for steering of the work vehicle.

The invention also provides a method for adjusting one or both of the tracking (toe in/toe out) and the camber of a ground engaging wheel of a wheeled work vehicle, wherein the wheeled work vehicle comprises a chassis, at least one ground engaging wheel carried on a suspension arm, the suspension arm extending from a first end to a second end and carrying the ground engaging wheel adjacent the second end thereof, the first end of the suspension arm being pivotally coupled to the chassis about a main transverse pivot axis extending transversally of the normal forward direction of travel of the work vehicle, the first end of the suspension arm having a main bore extending therethrough for accommodating a pivot shaft extending therethrough, the pivot shaft defining the main transverse pivot axis, at least one mounting bracket mounted on the chassis and defining a secondary bore extending therethrough for accommodating the pivot shaft therein, the method comprising providing a plurality of selectable adjustment elements, each adjustment element comprising an engagement member defining an engagement member central axis and engageable in one of the secondary bore extending through the at least one mounting bracket or the main bore extending through the suspension arm, and having a pivot shaft engagement bore extending therethrough engageable with the pivot shaft and defining an engagement bore central axis, the spacing between the engagement bore pivot axis and the engagement member pivot axis adjacent the engagement bore thereof of at least one of the adjustment elements being different to the spacing between the engagement bore central axis and the engagement member central axis adjacent the engagement bore thereof of the other ones of the adjustment elements, selecting at least one of the adjustment elements, and engaging the engagement member of the selected adjustment element in either the secondary bore of the mounting bracket or the main bore of the suspension arm for adjusting one or both of the tracking or the camber of the corresponding ground engaging wheel.

In one embodiment of the invention the engagement bore central axis and the engagement member central axis extend substantially parallel to each other.

In another embodiment of the invention a pair of spaced apart mounting brackets are provided, with the first end of the suspension arm located therebetween.

Preferably, two of the adjustment elements are selected and engaged in the secondary bores of the respective mounting brackets, or are engaged spaced apart in the main bore of the suspension arm.

In another embodiment of the invention the spacings between the engagement bore central axis and the engagement member central axis adjacent the engagement bore thereof of each of the adjustment elements of the selected pair thereof for adjusting the tracking or the camber of the ground engaging wheel of the at least one of the suspension arms are substantially similar.

In a further embodiment of the invention the spacing between the engagement bore central axis and the engagement member central axis adjacent the engagement bore thereof of one of the adjustment elements of the selected pair thereof for adjusting the tracking or the camber of the ground engaging wheel of the at least one of the suspension arms is different to the spacing between the engagement bore central axis and the engagement member central axis adjacent the engagement bore thereof of the other one of the adjustment elements of the selected pair thereof.

In another embodiment of the invention, the adjustment elements of the selected pair thereof are engaged in the secondary bores of the corresponding pair of the mounting brackets or in the main bore defined by the corresponding suspension arm with the orientation of the respective adjustment elements being the same or different.

Additionally, the invention provides an adjustment element for adjusting one or both of the tracking or the camber of a ground engaging wheel of a wheeled work vehicle according to the invention

Additionally, the invention provides an adjustment element for use in the method according to the invention for adjusting one or both of the tracking or the camber of a ground engaging wheel of a wheeled work vehicle.

In one embodiment of the invention the adjustment element comprises an engagement member configured for engaging one of a secondary bore of a mounting bracket mounted on a chassis of a wheeled work vehicle, or a main bore of a pivot mounting member of a suspension arm carrying a ground engaging wheel, the engagement member of the adjustment element defining an engagement member central axis and having a pivot shaft engagement bore extending therethrough defining an engagement bore central axis, the engagement bore central axis coinciding with the engagement member central axis adjacent the engagement bore or being spaced apart from the engagement member central axis adjacent the engagement bore thereof.

In another embodiment of the invention the adjustment element comprises a keying means for keying the adjustment element in the secondary bore of one of the mounting brackets or of the main bore in the pivot mounting member of the suspension arm in at least one orientation.

Preferably, a plurality of adjustment elements are provided, and the spacing between the engagement bore central axis and the engagement member central axis of the engagement member adjacent the pivot shaft engagement bore thereof in at least one of the adjustment elements is different to the spacing between the engagement bore central axis and the engagement member central axis adjacent the pivot shaft engagement bore of the engagement member of others of the adjustment elements.

The advantages of the invention are many. A particularly important advantage of the invention is that the available space between the suspension arms of each pair thereof within the wheeled work vehicle is increased without any increase in the overall width of the wheel base defined by the forward and/or rearward pairs of ground engaging wheels. This advantage is achieved by virtue of the fact that the electric motors of the respective ground engaging wheels are mounted on the outer sides of the suspension arms and extend sidewardly outwardly therefrom, and substantially the entire axial length of each electric motor extends into and within the well of the wheel rim of the corresponding ground engaging wheel. Additionally, since the electric motors are mounted on the outside of the respective suspension arms, the inner sides of the suspension arms are free of motors and other drive equipment. Thereby the available space between the pairs of the suspension arms of the pairs of the forward and rearward ground engaging wheels is increased without any increase in the width of the wheel base of the wheeled work vehicle. The increase in the available space between the suspension arms of the respective pairs of the forward and/or rearward ground engaging wheels is particularly advantageous, in that it leaves additional room in the wheeled work vehicle between the suspension arms of the rearward ground engaging wheels for accommodating, for example, the one or more large rechargeable batteries for powering the electric motors and other electrically powered components of the wheeled work vehicle.

In some cases, the increase in the available space between the suspension arms of the rearward ground engaging wheels may be used to accommodate a power generator, which may be powered by, for example, an internal combustion engine, both of which may be located in the available space between the corresponding pair of suspension arms. The additional available space between the suspension arms of the forward ground engaging wheels leaves additional space for accommodating the drivers cab therebetween.

Additionally, the increase in the available space between the suspension arms of the rearward ground engaging wheels may also be utilised for accommodating other components of the wheeled work vehicle, for example, vacuum systems for road and ground sweeping equipment of the wheeled work vehicle. Since the motors firstly, are located on the outer sides of the suspension arms, and secondly, and most importantly are located substantially within the wells of the wheel rims of the ground engaging wheels, the space between the suspension arms of the pairs thereof of the respective forward and rearward parts of the work vehicle is free of motors and other wheel drive elements, with no additional increase in the width of the wheel base of the work vehicle. A further advantage of the invention is that by the provision of the increase in the available space between the suspension arms of the rearward ground engaging wheels, extra large batteries may be accommodated between the suspension arms of the rearward ground engaging wheels, thereby, significantly extending the range of the wheeled work vehicle between battery charges.

Additionally, by providing the electrically powered motors to be of diameter less than the diameter of the well of the wheel rims of the ground engaging wheels, the electrically powered motors fit comfortably within the well of the corresponding wheel rims. By providing the electrically powered motors to be of axial length slightly greater than the depth of the wells of the wheel rims of the ground engaging wheels, the motors fit within the wells of the wheel rims of the ground engaging wheels, with just a portion of the motors extending therefrom sufficient to provide necessary clearance between the wheel rims and the inner wall of the corresponding tyre and the suspension arms with no increase in the overall width of the work vehicle.

Another particularly important advantage of the invention is achieved by the provision of the adjustment elements for adjusting the tracking and the camber of the ground engaging wheels of the work vehicle. The provision of the adjustment elements allows the tracking and the camber of the ground engaging wheels to be readily, easily and accurately adjusted, and furthermore, the adjustment elements provide a relatively simple and inexpensive arrangement whereby the ground engaging wheels may be mounted on a chassis of a wheeled work vehicle for ready, easy and accurate adjustment and setting of the tracking and the camber of the ground engaging wheels, both during assembly of the wheeled work vehicle and subsequently during servicing of the wheeled work vehicle.

The invention will be more clearly understood from the following description of a preferred embodiment thereof which is given by way of example only with reference to the accompanying drawings, in which:

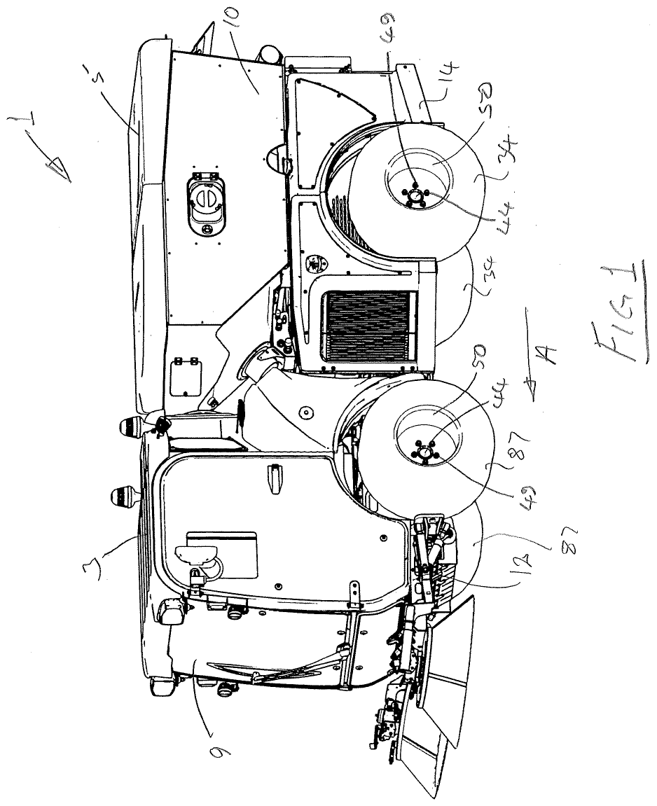

FIG. 1 is a perspective view of a wheeled work vehicle according to the invention,

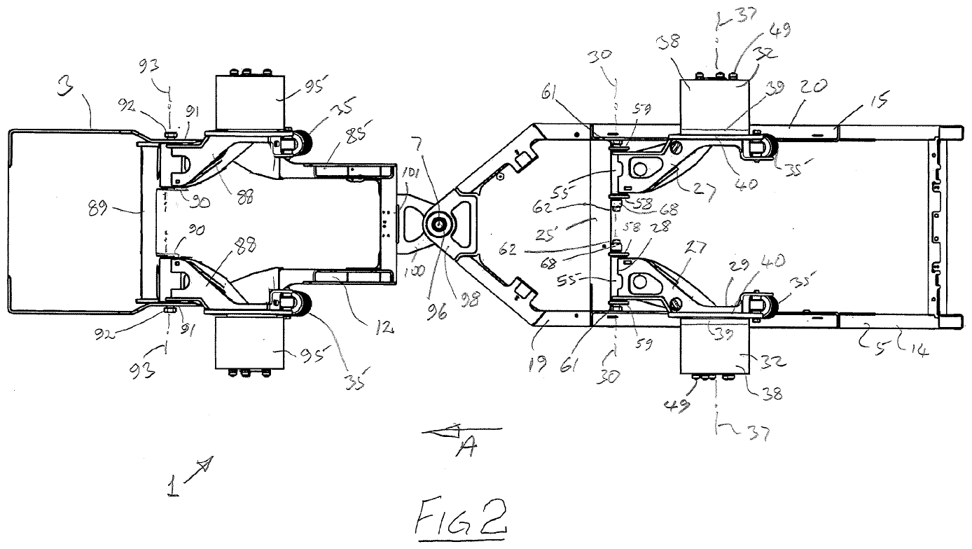

FIG. 2 is a diagrammatic underneath plan view of the wheeled work vehicle of FIG. 1,

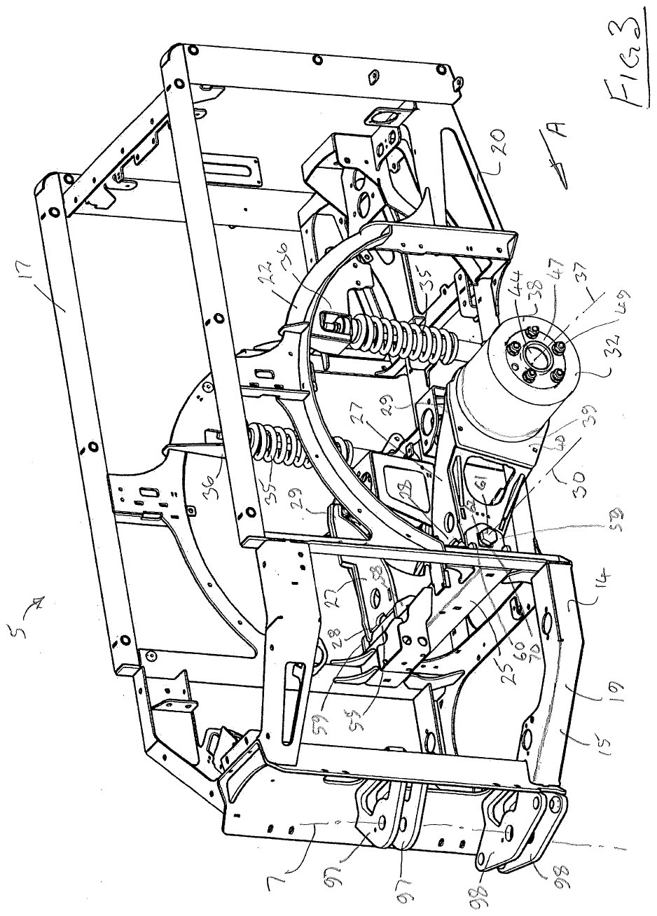

FIG. 3 is a perspective view of a rearward portion of the wheeled work vehicle of FIG. 1,

FIG. 4 is a side elevational view of the rearward portion of FIG. 3 of the wheeled work vehicle of FIG. 1,

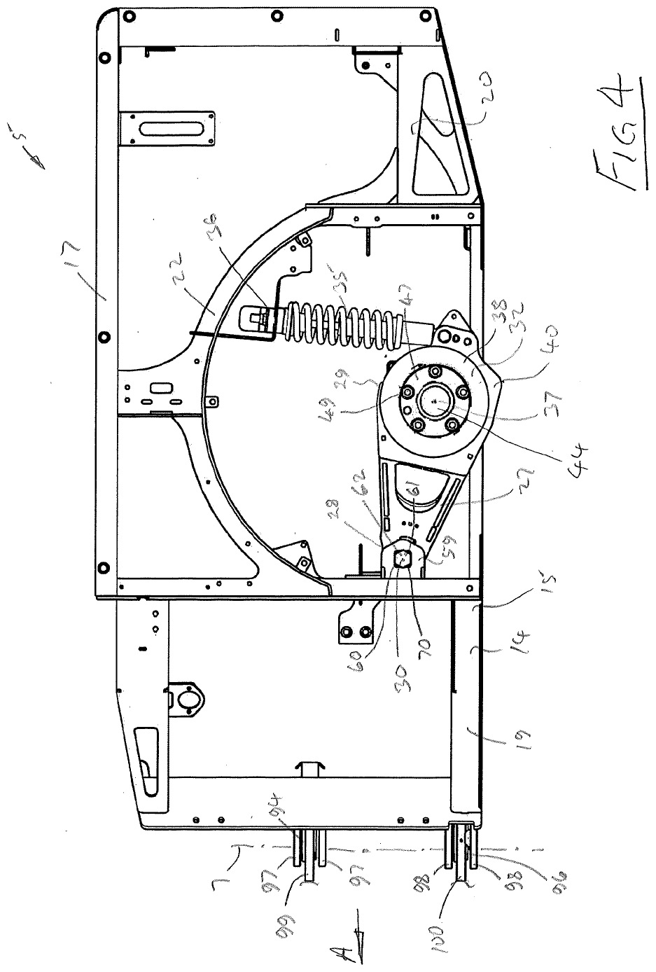

FIG. 5 is a top plan view of the rearward portion of FIG. 3 of the wheeled work vehicle of FIG. 1,

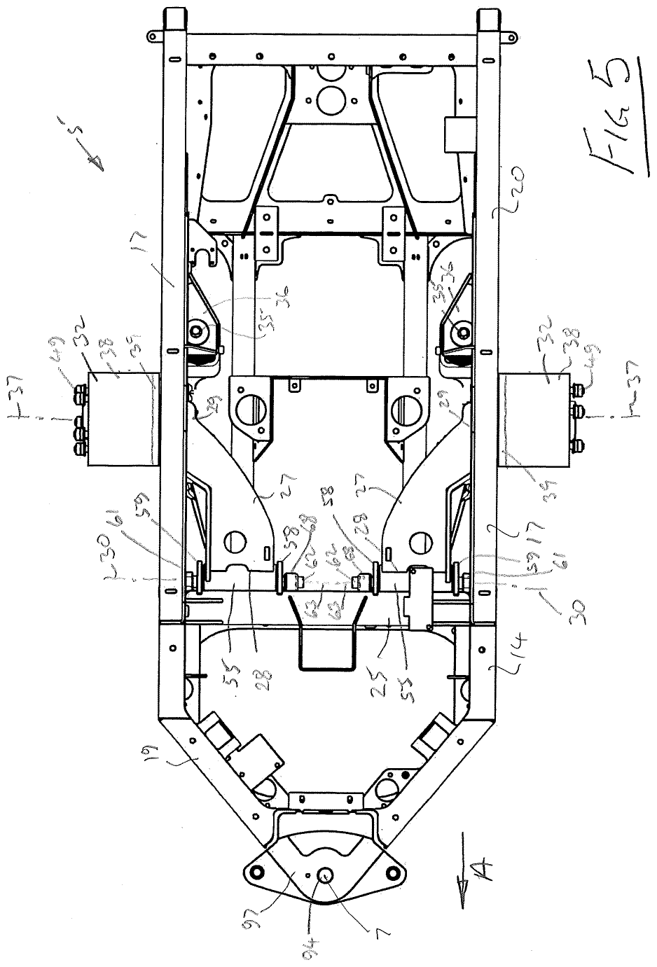

FIG. 6 is an underneath plan view of the rearward portion of FIG. 3 of the wheeled work vehicle of FIG. 1,

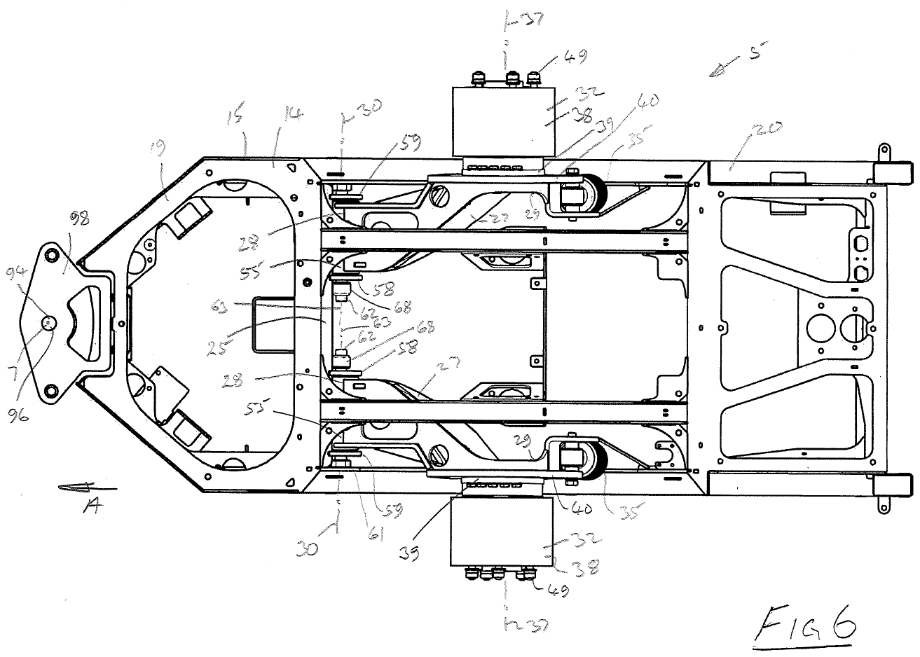

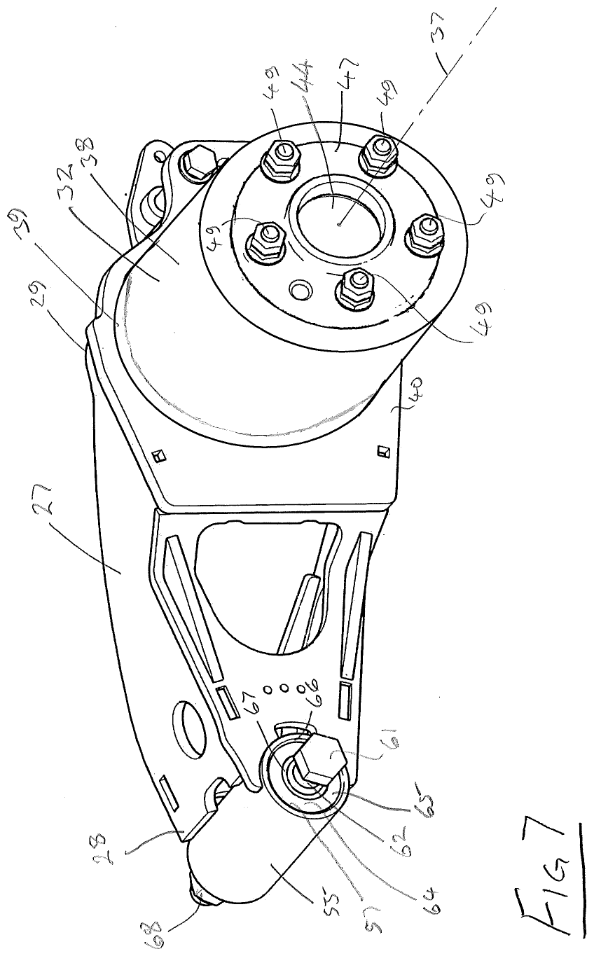

FIG. 7 is a perspective view of a suspension arm of the wheeled work vehicle of FIG. 1,

FIG. 8 is another perspective view of the suspension arm of FIG. 7 of the wheeled work vehicle of FIG. 1,

FIG. 9 is a side elevational view of the suspension arm of FIG. 7 of the wheeled work vehicle of FIG. 1,

FIG. 10 is a top plan view of the suspension arm of FIG. 7 of the wheeled work vehicle of FIG. 1,

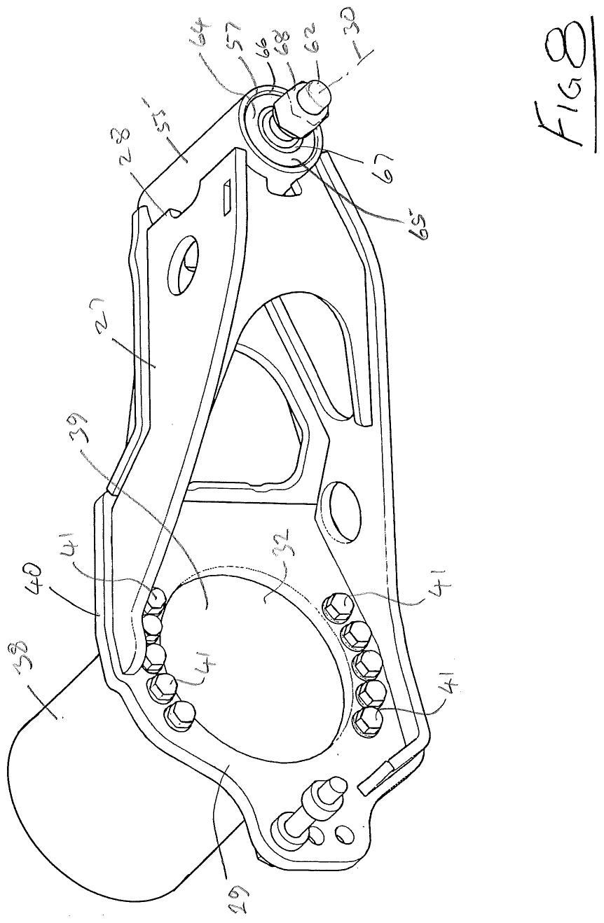

FIG. 11 is partly cross-sectional top plan view of the suspension arm of FIG. 7 of the wheeled work vehicle of FIG. 1,

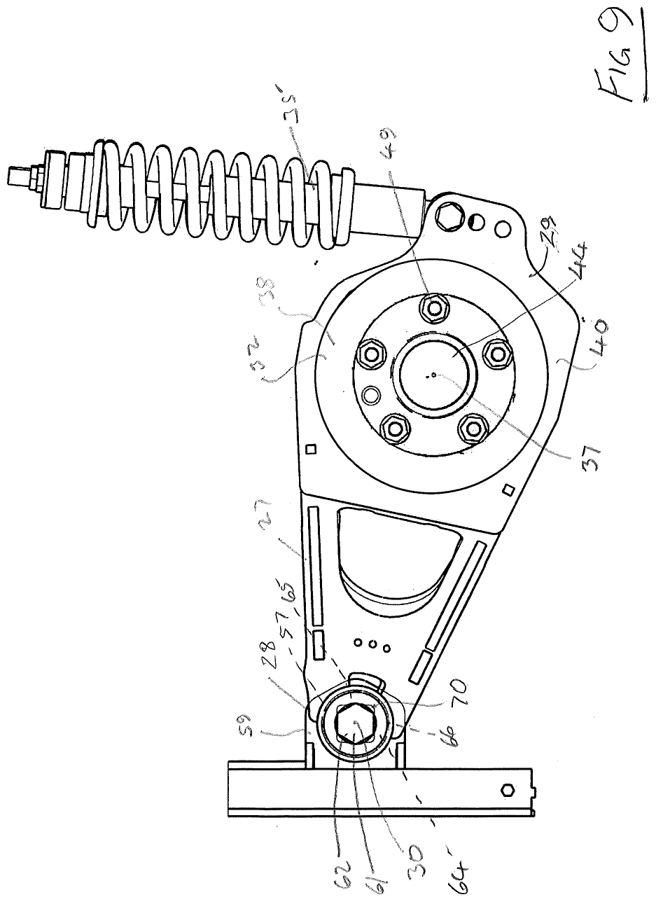

FIG. 12 is a top plan view of the suspension arm of FIG. 7 with a wheel illustrated in cross-section attached thereto of the wheeled work vehicle of FIG. 1,

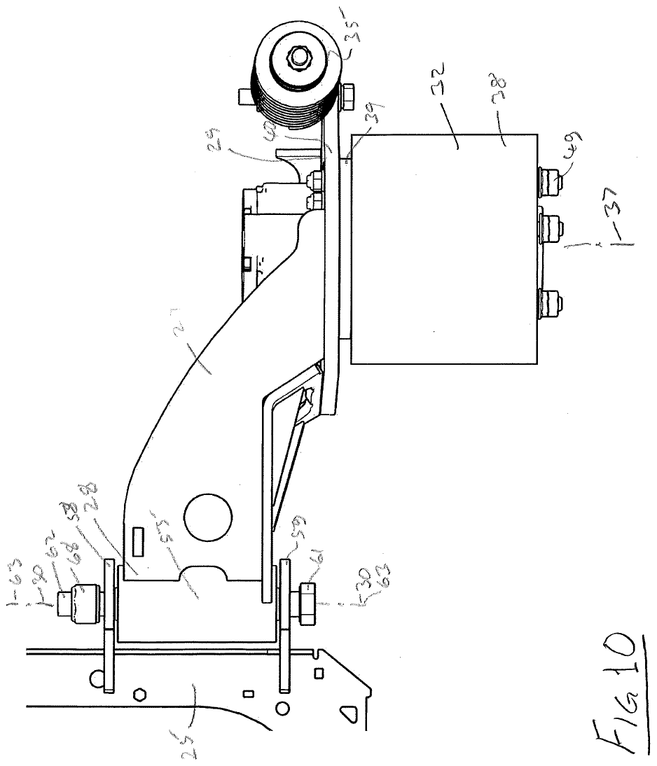

FIG. 13 is a perspective view of an adjustment element of the wheeled work vehicle of FIG. 1,

FIG. 14 is a side elevational view of the adjustment element of FIG. 13 of the wheeled work vehicle of FIG. 1,

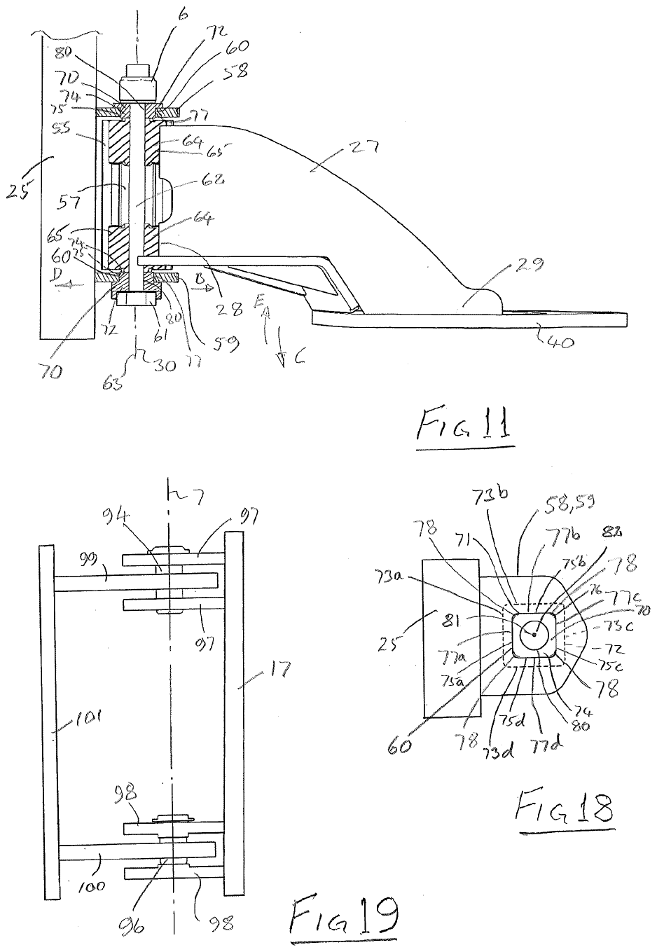

FIG. 15 is a side elevational view of another adjustment substantially similar to the adjustment element of FIG. 13 of the wheeled work vehicle of FIG. 1,

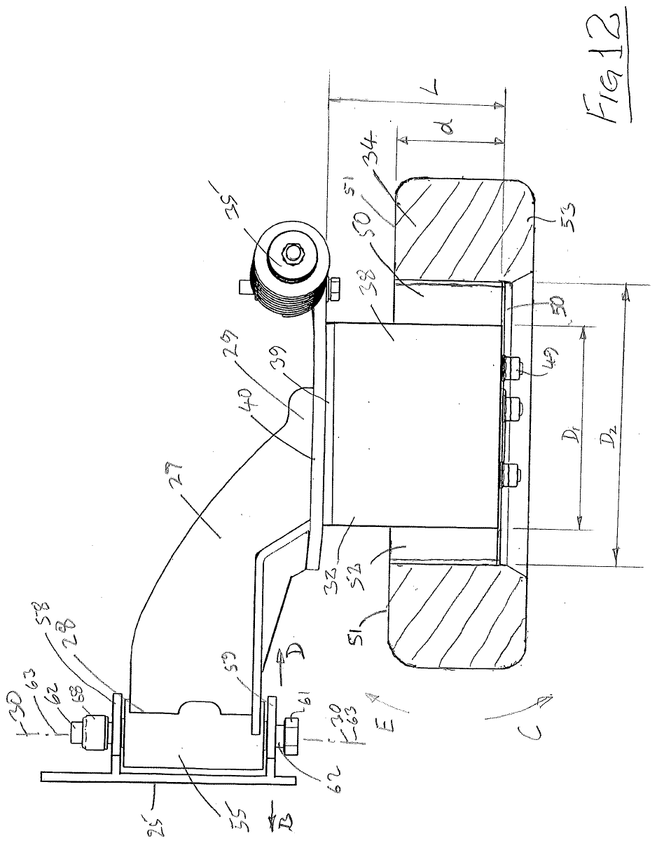

FIG. 16 is a side elevational view of another adjustment element substantially similar to the adjustment element of FIG. 13 of the wheeled work vehicle of FIG. 1,

FIG. 17 is a side elevational view of a further adjustment element substantially similar to the adjustment element of FIG. 13 of the wheeled work vehicle of FIG. 1,

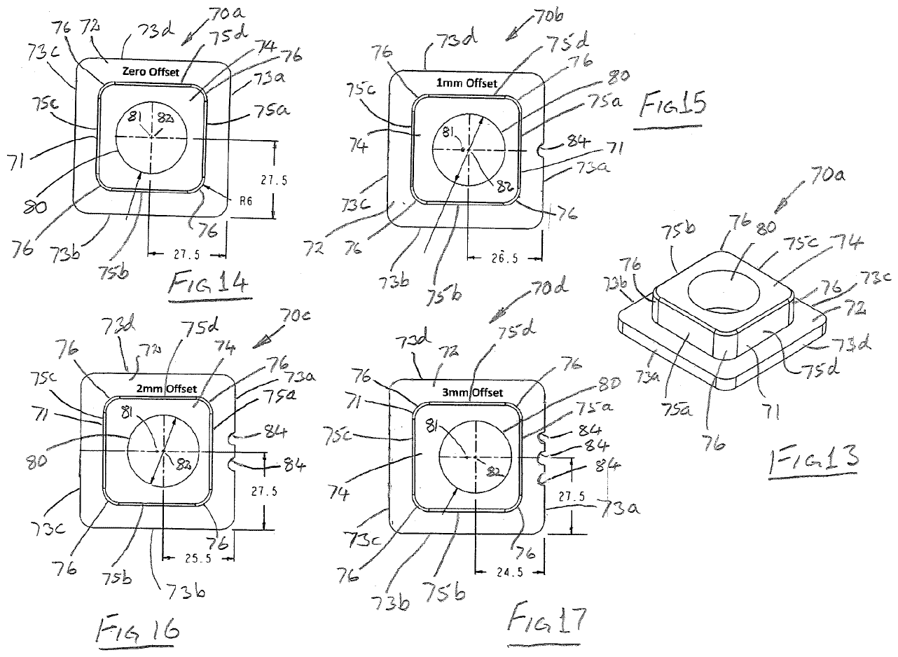

FIG. 18 is a side elevational view of a detail of the wheeled work vehicle of FIG. 1,

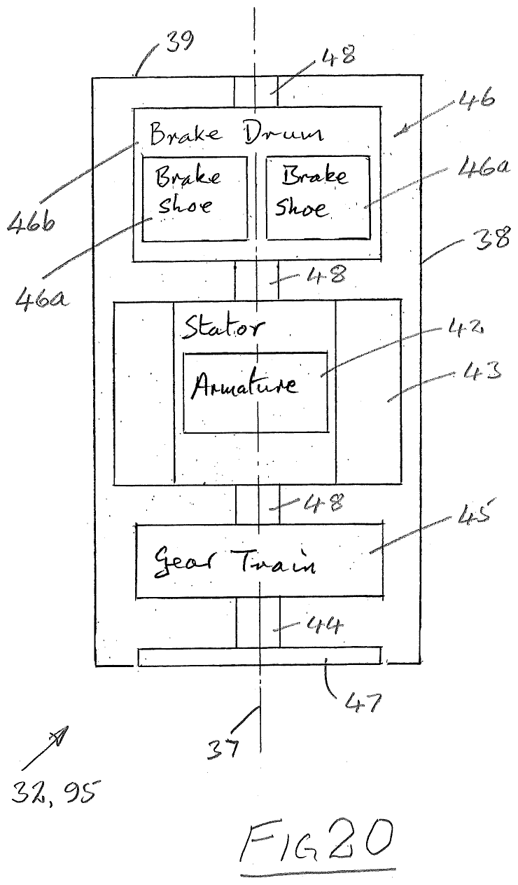

FIG. 19 is a side elevational view of another detail of the wheeled work vehicle of FIG. 1, and

FIG. 20 is a block representation of an electrically powered motor of the wheeled work vehicle of FIG. 1.

Referring to the drawings there is illustrated a wheeled work vehicle according to the invention indicated generally by the reference numeral 1. The work vehicle 1 comprises a forward part 3 and a rearward part which are pivotally coupled together about a vertically extending primary pivot axis 7. The work vehicle 1 in this embodiment of the invention is configured as a road sweeping vehicle, although, the work vehicle may be configured as any other type of a work vehicle. The forward part 3 comprises a driver's cab 9, and since the work vehicle 1 in this case is configured as a road sweeping vehicle, the rearward part 5 houses a vacuum system for drawing litter and other debris from the road as well as a bin in which the collected litter and debris is stored. Neither the vacuum system nor the bin are specifically illustrated, however, both are housed within a housing 10 of the rearward part 5. The forward part 3 of the work vehicle 1 comprises a forward chassis 12 and the rearward part 5 of the work vehicle 1 comprises a rearward chassis 14.

Turning initially to the rearward chassis 14, the rearward chassis 14 comprises a base chassis 15 and a super structure framework 17 mounted on and extending upwardly from the base chassis 15. The housing 10 of the rearward part 5 is mounted on the super structure framework 17. The base chassis 15 comprises a forward section 19 and a rearward section 20 which are joined by a central section 22. A transversely extending cross-member 25 is mounted on the forward section 19 and extends transversely relative to the normal forward direction of travel of the work vehicle 1, namely, the direction of the arrow A, see FIG. 1.

A pair of transversely spaced apart rearward suspension arms 27, each of which extends from a first end 28 to a second end 29, are pivotally coupled adjacent their respective first ends 28 to the cross-member 25 about respective rearward main transverse pivot axes 30, as will be described below, extending transversely of the normal forward direction of travel of the work vehicle 1. The rearward main transverse pivot axes 30 of the rearward suspension arms 27 are substantially aligned with each other, as will also be described in more detail below. Each rearward suspension arm 27 extends generally rearwardly from the corresponding rearward main transverse pivot axis 30 and carries an electrically powered motor 32 adjacent the second end 29 thereof for driving a corresponding one of a pair of transversely spaced apart rearward ground engaging wheels 34, as will also be described in more detail below. A pair of shock absorbers 35 are secured to the second ends 29 of the respective rearward suspension arms 27 and are secured to mountings 36 on the super structure framework 17.

Referring now to FIG. 12, the electrically powered motors 32 and their mounting to the corresponding rearward suspension arms 27 will now be described. Each electrically powered motor 32 comprises a substantially cylindrical housing 38 extending from a rear mounting element, in this embodiment of the invention a rear mounting plate 39. The rear mounting plate 39 is secured to a carrier plate 40 secured to the corresponding rearward suspension arm 27 adjacent the second end 29 thereof by screws 41, see FIG. 8.

A drive means comprising an output drive shaft 44 is rotatably mounted in the housing 38 on bearings (not shown) about a drive axis 37, and terminates in a carrier element, namely, a carrier plate 47 of circular shape mounted fast on the output drive shaft 44. Five threaded studs 49 extend from the carrier plate 47 for engaging a wheel rim 50 of the corresponding one of the rearward ground engaging wheels 34, for in turn securing the rearward ground engaging wheel 34 to the carrier plate 47 with the motor 32 located within a well 52 of the wheel rim 50.

The outer diameter D₁ of the housing 38 of each motor 32 is less than the inner diameter D₂ of the well 52 of the wheel rim 50, so that the motor 32 fits within the well 52 of the wheel rim 50 of the corresponding rear ground engaging wheel 34. Additionally, the overall length L of the motor 32 from the rear mounting plate 39 to the carrier plate 47 is slightly greater than the depth d of the well 52 of the wheel rim 50 of the corresponding rearward ground engaging wheel 34. Accordingly, each motor 32 fits within the well 52 of the corresponding wheel rim 50 with just a small amount of the motor 32 projecting outwardly therefrom, which is sufficient to space the corresponding wheel rim 50 and an inner wall 51 of a tyre 53 mounted on the wheel rim 50 a suitable distance from the corresponding suspension arm 27 and the rearward chassis 12.

Referring now to FIG. 20, each electrically powered motor 32 comprises an armature 42 and a stator 43 of the drive means, indicated in block representation in FIG. 20. The armature 42 and the stator 43 are located in the housing 38 of the electrically powered motor 32, and the armature 42 is mounted fast on a primary drive shaft 48 also of the drive means and also located within the housing 38. The primary drive shaft 48 is rotatably mounted on bearings in the housing 38, and produces the primary drive for the motor 32. A speed reduction means, in this case comprising a speed reduction gear train 45, also shown in FIG. 20 in block representation, is located in the housing 38 of each motor 32 for stepping-down the drive from the primary drive shaft 48 and applying the stepped-down drive to the output drive shaft 44. In this embodiment of the invention the speed reduction gear train 45 comprises ring gears together with cooperating planet gears. In some embodiments of the invention depending on the speed of the primary drive shaft 48, instead of a speed reduction means, a speed increasing means may be provided to step-up the rotational speed of the drive applied to the output drive shaft 44. Such a speed increasing means would typically comprise a gear train comprising one or more ring gears and cooperating planet gears.

A braking system 46, also shown in block representation in FIG. 20, is located within the housing 38 of each motor 32 and cooperates with the drive means thereof, in this case the primary drive shaft 48 for braking the motor 32. The braking system 46 comprises a shoe brake 46, which acts as a dynamic brake for slowing the wheeled work vehicle 1 and for bringing it to a halt during normal driving of the work vehicle 1. The shoe brake 46 comprises a pair of brake shoes 46a acting on an inner circumferential surface of a brake drum 46b mounted fast on the primary drive shaft 48. The shoe brake 46 as well as acting as a dynamic brake for slowing the wheeled work vehicle 1 and bringing it to a halt during normal driving of the work vehicle 1, also acts as a parking brake for preventing movement of the work vehicle 1. The brake shoes 46a of the shoe brake 46 are operated hydraulically for dynamic braking of the work vehicle 1, and are operated by a linkage mechanism or a cable when acting as a parking brake. The linkage mechanism or the cable may be manually operated or motor operated, for example, by a servo motor. The dynamic operation of such brake shoes 46a hydraulically for dynamic braking of the work vehicle 1, and the operation of the brake shoes 46a by a linkage mechanism or a cable, will be well known to those skilled in the art.

Suitable electrical and electronic control circuitry (not shown) is provided for controlling the speed of the electric motors 32, and in turn the speed of the output drive shaft 44, as well as the rotational direction of the drive, for in turn controlling the speed and direction in which the wheeled work vehicle 1 is moving. The control circuitry is located in any suitable location in the work vehicle 1, and is controlled from the cab 9 by the driver of the wheeled work vehicle, as will be well known to those skilled in the art.

The electrically powered motors 32 are battery powered by a large rechargeable battery (not shown) located in the rearward chassis 14 of the rearward part 5 of the wheeled work vehicle and between the rearward suspension arms 27.

Returning now to the pivotal mounting of the rearward suspension arms 27 about the respective rearward main transverse pivot axes 30. Each rearward suspension arm 27 terminates at its first end 28 in a transversely extending pivot mounting member 55 having a main bore 57 extending therethrough. A pair of spaced apart mounting brackets, namely, an inner mounting bracket 58 and an outer mounting bracket 59 are welded to and extend rearwardly from the cross-member 25 for pivotally carrying a corresponding one of the rearward suspension arms 27. The inner and outer mounting brackets 58 and 59 of each pair thereof are spaced apart to accommodate the pivot mounting member 55 of the corresponding rearward suspension arm 27 therebetween. Each inner and outer mounting bracket 58 and 59 is provided with a secondary bore 60 extending therethrough which is alignable with the main bore 57 of the pivot mounting member 55 of the corresponding rearward suspension arm 27.

A pivot shaft 62 extends through the main bore 57 of the pivot mounting member 55 of the corresponding rearward suspension arm 27 and through the secondary bores 60 in the corresponding inner and outer mounting brackets 58 and 59. The pivot shaft 62 defines a longitudinally extending central axis 63, which when the pivot mounting member 55 is pivotally mounted between the inner and outer mounting brackets 58 and 59 by the pivot shaft 62, as will be described below, the central axis 63 defined by the pivot shaft 62 defines the rearward main transverse pivot axis 30 about which the corresponding rearward suspension arm 27 is pivotal.

A pair of spaced apart bushes 64 located in the main bore 57, adjacent opposite ends thereof, of the pivot mounting member 55 centres and resiliently support the pivot shaft 62 in the main bore 57. Each bush 64 comprises an annular rubber element 65 located between an outer cylindrical shell (not shown) of steel engageable in the main bore 57, and an inner cylindrical shell (not shown) of steel engageable with the pivot shaft 62. The outer shell of each bush 64 is tightly and non-rotatably engaged in the main bore 57 of the corresponding pivot mounting member 55, and the inner shell of each bush 64 tightly and non-rotatably engages the pivot shaft 62, so that the pivot shaft 62 is non-rotatably mounted in the pivot mounting member 55, although in some embodiments of the invention the pivot shaft 62 may be rotatable in the inner shells of the bushes 64.

A plurality of selectable adjustment elements 70 engageable in the secondary bores 60 in the respective inner and outer mounting brackets 58 and 59 are provided for adjusting the tracking (toe-in, toe-out) of the corresponding rearward ground engaging wheel 34 and also for adjusting the camber of the corresponding rearward ground engaging wheel 34. In this embodiment of the invention four types of the adjustment elements 70 are provided, namely, adjustment elements 70a, 70b, 70c and 70d, as will be described below. Each adjustment element 70 comprises a plate 72 of steel of substantially square shape having four side edges 73a, 73b, 73c and 73d, and having an engagement member 74 also of steel integrally formed with the plate 72 and extending therefrom of substantially square outer cross-sectional shape, the outer periphery 71 of which is defined by four side faces 75a, 75b, 75c and 75d, which are joined by four radiused corners 76 for engaging either one of the secondary bores 60 of the inner and outer mounting brackets 58 and 59.

The secondary bores 60 of the inner and outer mounting brackets 58 and 59 for mounting each suspension arm 27 are of shape complementary to the outer periphery 71 of the engagement member 74 of the adjustment elements 70, and are also of substantially square cross-section defining four side faces 77a, 77b, 77c and 77d joined by radiused corners 78. The area and cross-section of the secondary bores 60 through the inner and outer mounting brackets 58 and 59 are substantially similar to the area and cross-section defined by the engagement members 74 of adjustment elements 70, see FIG. 18. Thereby, the engagement members 74 of the adjustment elements 70 are a tight fit in the secondary bores 60 of the inner and outer mounting brackets 58 and 59, and the side faces 75a, 75b, 75c and 75d of the engagement members 74 cooperate with the side faces 77a, 77b, 77c and 77d of the secondary bores 60 to act as a keying means for keying the adjustment elements 70 in the secondary bores 60 as will be described below.

A pivot shaft engagement bore 80 of circular cross-section extends through the engagement member 74 and through the plate 72 of each adjustment element 70 for pivotally engaging the pivot shaft 62. The engagement member 74 of each adjustment element 70 defines an engagement member central axis 81. The pivot shaft engagement bore 80 of each adjustment element 70 defines an engagement bore central axis 82. The engagement bore central axis 82 and the engagement member central axis 81 extend parallel to each other. The engagement member central axis 81 of each engagement member 74 extends through the point of intersection of a pair of diagonal lines extending from diagonally opposite corners (not shown) of the engagement member 74 defined by the intersection of extensions of adjacent pairs of the side faces 75a to 75d of the corresponding engagement member 74.

As mentioned above, in this embodiment of the invention, four different types of the adjustment elements are provided, namely, the adjustment elements 70a to 70d, and each of the adjustment elements 70a to 70d are engageable with each of the secondary bores 60 of the inner and outer mounting brackets 58 and 59. In one of the adjustment elements 70, namely, the adjustment element 70a, the engagement member central axis 81 and the engagement bore central axis 82 coincide with each other. Accordingly, when two of the adjustment elements 70a are engaged in the secondary bores 60 of a pair of the inner and outer mounting brackets 58 and 59, and the pivot shaft 62 is engaged in and extending through the pivot shaft engagement bores 80 of the adjustment elements 70a, the rearward main transverse pivot axis 30 defined by the pivot shaft 62 extends parallel with the cross-member 25 and transversely of the normal forward direction of travel of the work vehicle 1.

In each of the adjustment elements 70b to 70d, the pivot shaft engagement bore 80 is located in the engagement member 74 with the engagement bore central axis 82 thereof offset from the engagement member central axis 81 adjacent the engagement bore 80 and spaced apart from the engagement member central axis in a direction towards and perpendicular to the side face 75a of the engagement member 74. The amount by which the engagement bore central axis 82 of the pivot shaft engagement bore 80 is offset from the engagement member central axis 81 of the engagement member 74 of the respective adjustment elements 70b to 70d progressively increases incrementally from the adjustment element 70b to the adjustment element 70d. In this embodiment of the invention the incremental increase in the offset of the engagement bore central axis 82 from the engagement member central axis 81 adjacent the pivot shaft engagement bore 80 is 1 mm. In other words, in the adjustment element 70b, the engagement bore central axis 82 is spaced apart 1 mm from the engagement member central axis 81 adjacent the pivot shaft engagement bore 80.

In the adjustment element 70c, the spacing between the engagement bore central axis 82 and the engagement member central axis 81 is 2 mm, and the spacing between the engagement bore central axis 82 and the engagement member central axis 81 of the adjustment element 70d is 3 mm. However, it will be appreciated that the incremental increase in the offset between the engagement bore central axis 82 and the engagement member central axis 81 may be less than or greater than 1 mm. For example, the incremental increase in the offset between the engagement bore central axis 82 and the engagement member central axis 81 may by any incremental increase in the range of 0.25 mm to 3 mm, and in some cases may be less than 0.25 mm or greater than 3 mm. The number of adjustment elements 70 in which the offset of the engagement bore central axis 82 from the engagement member central axis 81 incrementally increases will be dependent on firstly, the maximum offset value of the engagement bore central axis 82 from the engagement member central axis 81, and secondly, on the fineness of the incremental offset value required. In other words, the fineness of the adjustment of the tracking and the camber required. It is envisaged that an adjustment element may be provided with an offset of the engagement bore central axis 82 from the engagement member central axis 81 of up to 3 mm and greater, with the appropriate number of other adjustment elements with the spacing between the engagement bore central axis 82 and the engagement member central axis 81 increasing incrementally to the 3 mm offset.

An indicating means for indicating the offset value, namely, the spacing of the engagement bore central axis 82 from the engagement member central axis 81 and its direction of offset from the engagement member central axis 81 is provided on each adjustment element 70b to 70d. In this embodiment of the invention the indicating means is provided by one or more notches 84 formed on one of the side edges 73 of the plate 72 of each adjustment element 70. The number of notches 84 indicates the number of increments by which the engagement bore central axis 82 of the pivot shaft engagement bore 80 is offset from the engagement member central axis 81. The side edge 73 of the plate 72 on which the notch 84 or notches 84 are formed indicates the side edge 73 which is adjacent the side face 75 of the engagement member 74 to which the direction of the offset of the engagement bore central axis 82 from the engagement member central axis 81 is perpendicular, and also indicates the side edge 73 which is adjacent the side face 75 of the engagement member 74 towards which the engagement bore central axis 82 is offset from the engagement member central axis 81. In this embodiment of the invention the engagement bore central axis 82 of the engagement member 74 of each of the adjustment elements 70b to 70d is offset from the engagement member central axis 81 in a direction towards and perpendicular to the side face 75a of the corresponding engagement member 74, and therefore, the notch 84 or notches 84 are formed on the side edge 73a of the adjustment elements 70b to 70d, which is adjacent the side face 75a of the engagement member 74.

In the adjustment element 70b one notch 84 is formed on the side edge 73a of the plate 72 thereof to indicate that the offset of the engagement bore central axis 82 from the engagement member central axis 81 is 1 mm. In the adjustment element 70c two notches 84 are formed on the side edge 73a thereof to indicate that the offset of the engagement bore central axis 82 from the engagement member central axis 81 is 2 mm. In the adjustment element 70d, three notches are provided on the side edge 73a of the plate 72 thereof indicating that the offset of the engagement bore central axis 82 from the engagement member central axis 81 is 3 mm. It will be appreciated that any other suitable indicating means may be provided, and as discussed above, where notches are provided, the notches will indicate the number of increments by which the engagement bore central axis 82 is offset from the engagement member central axis 81.

As mentioned above, the side faces 75a to 75d of the engagement member 74 of each adjustment element 70 cooperates with the side faces 77a to 77d of the secondary bore 60 of each of the inner and outer mounting brackets 58 and 59 to key the engagement member 74 in the secondary bore 60. Since as discussed above the outer periphery 71 of the engagement member 74 of each adjustment element 70 defined by the side faces 75a to 75d define a square with radiused corners 78, which is complementary to the square bore extending through the inner and outer mounting brackets 58 and 59 defined by the side faces 77a to 77d and the radiused corners 78 thereof, the engagement member 74 of each of the adjustment elements 70 may be keyed in the secondary bore 60 in any of four selectable orientations. In a first one of the four selectable orientations, the engagement member 74 is engaged in the secondary bore 60 with the side face 75a of the engagement member 74 engaging the side face 77a of the secondary bore 60. In this orientation, the engagement bore central axis 82 of the engagement member 74 is offset from the engagement member central axis 81 towards the side face 77a of the secondary bore 60. In a second one of the keyed orientations, the engagement member 74 is engaged in the secondary bore 60 with the side face 75a of the engagement member 74 engaging the side face 77c of the secondary bore 60. In this second orientation, the engagement bore central axis 82 of the engagement member 74 is offset from the engagement member central axis 81 towards the engagement face 77c of the secondary bore 60. These first and second orientations of the engagement member 74 of each of the adjustment elements 70 in the secondary bore 60 of the inner and outer mounting brackets 58 and 59 are used, as will be described below, for adjusting the tracking of the corresponding ground engaging wheel.

In a third one of the four keyed orientations, the engagement member 74 of each adjustment element 70 is engaged in the secondary bore 60 of the inner or outer mounting brackets 58 and 59 with the side face 75a of the engagement member 74 engaging the side face 77b of the secondary bore 60. In this third orientation of the engagement member 74, the engagement bore central axis 82 is located above the engagement member central axis 81, and is offset from the engagement member central axis 81 towards the side face 77b of the secondary bore 60. In the fourth one of the keyed orientations, the engagement member 74 of each adjustment element 70 is engaged in the secondary bore 60 of the inner or outer mounting brackets 58 and 59 with the side face 75a of the engagement member 74 engaging the side face 77d of the secondary bore 60 with the engagement bore central axis 82 located below the engagement member central axis 81 and offset towards the side face 77d of the secondary bore 60. The adjustment elements 70 are used in the third and fourth orientations for adjusting the camber of the corresponding ground engaging wheel 34.

The tracking of each one of the rearward ground engaging wheels 34 is carried out by selecting two suitable ones of the adjustment elements 70 for insertion in the secondary bores 60 of the inner and outer mounting brackets 58 and 59, which carry the corresponding rearward suspension arm 27, so that the portion of the pivot shaft 62 engaged in the pivot shaft engagement bore 80 of the adjustment element 70 in the secondary bore 60 of the outer mounting bracket 59 is urged forwardly or rearwardly of the portion of the pivot shaft 62 which is engaged in the pivot shaft engagement bore 80 of the adjustment element 70 in the secondary bore 60 of the inner mounting bracket 58, depending on whether toe-in or toe-out of the corresponding ground engaging wheel 34 is required.

Referring in particular to FIGS. 11 to 18, normally, the adjustment element 70a is located in the secondary bore 60 of the inner mounting bracket 58. To adjust the tracking to toe-in the corresponding rearward ground engaging wheel 34, in other words, to toe-in the forwardly facing part of the rearward ground engaging wheel 34 inwardly in the direction of the arrow E, see FIG. 12, the appropriate one of the adjustment elements 70b to 70d is selected, depending on the amount of toe-in required, and is inserted in the secondary bore 60 of the outer mounting bracket 59 with the engagement bore central axis 82 located forwardly of the engagement member central axis 81 thereof, namely, in the direction of the arrow B of FIG. 12 in other words, with the side face 75a of the engagement member 74 forward of the side face 75c thereof and engaging the side face 77a of the secondary bore 60 of the outer mounting bracket 59. The selection of the one of the adjustment elements 70b to 70d will be determined by the degree of toe-in of the corresponding rearward ground engaging wheel 34 in the direction of the arrow E required. Selecting the adjustment element 70b for insertion in the secondary bore 60 of the outer mounting bracket 59 provides the least amount of toe-in of the corresponding rearward ground engaging wheel 34, while selecting the adjustment element 70d provides the maximum amount of toe-in of the corresponding rearward ground engaging wheel 34.

On the other hand, with the adjustment element 70a engaged in the secondary bore 60 of the inner mounting bracket 58, should it be required to toe-out the corresponding rearward ground engaging wheel 34 in the direction of the arrow C, see FIG. 12, the appropriate one of the adjustment elements 70b to 70d is selected and engaged in the secondary bore 60 of the outer mounting bracket 59 with the engagement bore central axis 82 located rearwardly of engagement member central axis 81 thereof, namely, in the direction of the arrow D of FIG. 12. In other words, the selected one of the adjustment elements 70b to 70d with the side face 75a rearwardly of the side face 75c of the engagement member 74 thereof and with the side face 75a engaging the side face 77c of the secondary bore 60 of the outer mounting bracket 59. The selection of the adjustment element 70b to 70d is dependent on the amount of toe-out of the corresponding rearward ground engaging wheel 34 required. As in the selection of the appropriate one of the adjustment elements 70b to 70d for adjusting the toe-in, the adjustment element 70b provides the minimum degree of toe-out, while the adjustment element 70d provides the maximum degree of toe-out. If however a sufficient amount of toe-in or toe-out cannot be achieved with the adjustment element 70a located in the secondary bore 60 of the inner mounting bracket 58, the adjustment element 70a may be replaced by an appropriate one of the adjustment elements 70b to 70d. If the corresponding rearward ground engaging wheel 34 requires to be toed-in in the direction of the arrow E, see FIG. 12, the selected one of the adjustment elements 70b to 70d is inserted in the secondary bore 60 of the inner mounting bracket 58 with the engagement bore central axis 82 thereof located rearwardly of the engagement member central axis 81, and the selected one of the adjustment elements 70b to 70d inserted in the secondary bore 60 of the outer mounting backet 59 is located with the engagement bore central axis 82 located forwardly of the engagement member central axis 81. In other words, the selected one of the adjustment elements 70b to 70d is inserted in the secondary bore 60 of the inner mounting bracket 58 with the side face 75a of the engagement member 74 engaging the side face 77c of the secondary bore 60 of the inner mounting bracket 58, and the selected one of the adjustment elements 70b to 70d is inserted in the secondary bore 60 of the outer mounting bracket 59 with the side face 75a of the engagement member 74 engaging the side face 77a of the secondary bore 60 of the outer one of the mounting brackets 59. The selection of the two adjustment elements 70b to 70d for engagement in the secondary bores 60 of the inner and outer mounting brackets 58 and 59 again will be dependent on the amount of toe-in of the corresponding rearward ground engaging wheel 34 required. The maximum toe-in would be achieved by selecting two of the adjustment elements 70d, one for the inner mounting bracket and one for the outer mounting bracket, which would give double the amount of toe-in for the corresponding rearward ground engaging wheel 34 than would be achieved by inserting the adjustment element 70a in the secondary bore 60 of the inner mounting bracket 58 and the adjustment element 70d in the secondary bore 60 of the outer mounting bracket 59. It will readily be apparent to those skilled in the art that many combinations of the adjustment elements 70b to 70d may be selected for the inner and outer mounting brackets 58 and 59 to achieve toe-in or toe-out of the corresponding ground engaging wheel 34.

Additionally, instead of locating the adjustment element 70a in the secondary bore 60 of the inner mounting bracket 58, the adjustment element 70a may be located in the secondary bore 60 of the outer mounting bracket 59, and the one of the adjustment elements 70b to 70d may be located in the secondary bore 60 of the inner mounting bracket 58. Depending on whether the engagement bore central axis 82 of the selected one of the adjustment elements 70b to 70d was offset forwardly or rearwardly relative to the engagement member central axis 81, toe-in or toe-out of the corresponding rearward ground engaging wheel 34 would also be achieved.

Turning now to the adjustment of the camber of each of the rearward ground engaging wheels 34, and referring still to FIGS. 12 to 18, if the adjustment element 70a is located in the secondary bore 60 of the inner mounting bracket 58, to adjust the camber of the ground engaging wheel 34, an appropriate one of the adjustment elements 70b to 70d is selected, depending on the amount of adjustment of the camber required, for insertion in the secondary bore 60 of the outer mounting bracket 59. The selected one of the adjustment elements 70b to 70d, if the camber of the wheel is to be adjusted outwardly, in other words, if the lower ground engaging part of the corresponding ground engaging wheel 34 is to be urged outwardly and the upper part of the corresponding ground engaging wheel is to be urged inwardly, the selected one of the adjustment elements 70b to 70d is inserted in the secondary bore 60 of the outer mounting bracket 59 with the engagement bore central axis 82 located above the engagement member central axis 81. In other words, the selected one of the adjustment elements 70b to 70d is inserted in the secondary bore 60 of the outer mounting bracket 59 with the side face 75a of the engagement member 74 thereof above the side face 75c, and with the side face 75a of the engagement member 74 engaging the side face 77b of the secondary bore 60 of the outer mounting bracket 59.

If the camber is to be adjusted inwardly, in other words, in the reverse direction, with the lower ground engaging part of the corresponding ground engaging wheel being urged inwardly, and the upper part of the corresponding ground engaging wheel being urged outwardly, the selected one of the adjustment elements 70b to 70d is located in the secondary bore 60 of the outer mounting bracket 59 with the engagement bore central axis 82 located below the engagement member central axis 81. In other words, the selected one of the adjustment elements 70b to 70d is inserted in the secondary bore 60 of the outer mounting bracket 59 with the side face 75a of the engagement member 74 engaging the side face 77d of the secondary bore 60 of the outer one of the mounting brackets 59. As with the adjustment of the tracking of the rearward ground engaging wheels 34, the degree of camber adjustment is dependent on the selected one of the adjustment elements 70b to 70d. With the adjustment element 70a located in one of the inner or outer mounting brackets 58 or 59, the minimum camber adjustment is achieved by selecting the adjustment element 70b for insertion in the other one of the inner or outer mounting brackets 58 or 59, while the maximum camber adjustment is achieved by selecting the adjustment element 70d for insertion in the other one of the inner or outer brackets 58 or 59.

However, if greater camber adjustment is required, one of the selected pair of the adjustment elements 70 may include any one of the adjustment elements 70b to 70d, and the other one of the pair may also include any one of the adjustment elements 70b to 70d. The maximum camber adjustment would be achieved by using two of the adjustment elements 70d, with one of the adjustment elements 70d located in one of the inner or outer mounting brackets 58 or 59 with the engagement bore central axis 82 above the engagement member central axis 81 of the engagement member 74 thereof, and the other one of the adjustment elements 70d located in the other one of the inner or outer mounting brackets 58 or 59 with the engagement bore central axis 82 thereof located below the engagement member central axis 81.

Additionally, as with the adjustment of the tracking of the rearward ground engaging wheels, if one of the selected adjustment elements is the adjustment element 70a, the adjustment element 70a may be located in the inner or the outer mounting brackets 58 or 59, and the selected one of the adjustment elements 70b to 70d would be engaged in the other one of the inner and outer mounting brackets 58 or 59. Needless to say, two of the adjustment elements 70a may be selected, one for the inner mounting bracket and one for the outer mounting bracket.

Additionally, if adjustment of both tracking and camber are required, both may be adjusted simultaneously by selecting the appropriate one of the adjustment elements 70a to 70d to provide camber adjustment, and inserting the selected one of the adjustment elements 70a to 70d selected for camber adjustment in the inner or outer mounting brackets 58 or 59 with the engagement bore central axis 82 located either above or below the engagement member central axis 81 thereof. The appropriate one of the adjustment elements 70a to 70d for adjusting the tracking is selected for insertion in the other one of the inner and outer mounting brackets 58 or 59, and is inserted in the one of the inner and outer mounting brackets 58 or 59 with the engagement bore central axis 82 located either forwardly or rearwardly of the engagement member central axis 81 thereof depending on whether toe-in or toe-out is required.

As discussed above, the rearward main transverse pivot axes 30 defined by the respective pivot shafts 62 about which the corresponding rearward suspension arms 27 are pivotal, are substantially aligned with each other. If the adjustment elements 70 engaged in the inner and outer mounting brackets 58 and 59 of the respective rearward suspension arms 27 are the adjustment elements 70a, then the rearward main transverse pivot axes 30 of the two rearward suspension arms 27 would be substantially fully axially aligned and would substantially coincide with each other. However, if adjustment of the tracking and/or camber is required and different ones of the adjustment elements 70a to 70d are located in the inner and outer mounting brackets 58 and 59 of the respective rearward suspension arms 27, then the rearward main transverse pivot axes 30 defined by the respective pivot shaft 62 will not be aligned, but rather, will extend at an angle relative to each other, or may extend parallel to each other but spaced apart from each other. This will be well understood by those skilled in the art.

Each pivot shaft 62 comprises a bolt having a head 61 and a nut 68, between which the corresponding inner and outer mounting brackets 58 and 59 are located, as well as the corresponding pivot mounting member and the adjustment elements 70 of the corresponding rearward suspension arm 27 are secured.

The adjustment elements 70 are engaged in the corresponding inner and outer mounting brackets 58 and 59 with the plates 72 thereof abutting the respective inner and outer mounting brackets 58 and 59 and located between the corresponding one of the inner and outer mounting brackets 58 and 59 and the adjacent one of the head 61 or the nut 68 of the pivot shaft 62, see FIG. 11.

Turning now to the forward chassis 12, the forward chassis 12, which is illustrated diagrammatically in FIG. 2, comprises a base chassis 85, somewhat similar to the base chassis 15 of the rearward chassis 14, and a super structure framework (not shown). However, the base chassis 85 and the super structure framework (not shown) of the forward chassis 12 are appropriately constructed and shaped to suit the driver's cab 9 and other aspects of the forward part 3 of the work vehicle 1. A pair of spaced apart forward ground engaging wheels 87 are carried on respective forward suspension arms 88. The forward suspension arms 88 are substantially similar to the rearward suspension arms 27, and similar components are identified by the same reference numerals.

Each forward suspension arm 88 is pivotally coupled to a transversely extending cross-member 89 of the forward chassis 12 about a corresponding forward main transverse pivot axis 93 and extends rearwardly from the forward main transverse pivot axis 93 in a similar manner as the rearward suspension arms 27 are pivotally coupled to the rearward chassis 14 about the respective rearward main transverse pivot axis 30. Each forward suspension arm 88 terminates in its first end 28 in a pivot mounting member 55 similar to the pivot mounting member 55 of the rearward suspension arms 27. The pivot mounting member 55 of each forward suspension arm 88 is pivotally coupled to the cross-member 89 by a pivot shaft 92 extending between and carried in inner and outer mounting brackets 90 and 91, which are similar to the inner and outer mounting brackets 58 and 59, and each one of the inner and outer mounting brackets 90 and 92 has a secondary bore 60 extending therethrough, which is similar to the secondary bores 60 extending through the inner and outer mounting brackets 58 and 59. The pivot shaft 92 is similar to the pivot shaft 62 and defines the forward main transverse pivot axis 93 about which the corresponding forward suspension arm 88 is pivotal. Appropriate ones of the adjustment elements 70a to 70d are selected and are engaged in the secondary bores 60 of the inner and outer mounting brackets 90 and 91 with the pivot shaft 92 engaged in the pivot shaft engagement bores 80 of the adjustment elements 70, so that the tracking and camber of the corresponding forward ground engaging wheel 87 are as desired, in a similar manner as already described with reference to the pivotal coupling of the rearward suspension arms 27 to the inner and outer mounting brackets 58 and 59. Thus, the tracking (toe-in/toe-out) and the camber of the forward ground engaging wheels 87 is also adjustable by selecting the appropriate ones of the adjustment elements 70a to 70d in a similar manner as the adjustment elements 70a to 70d are selected for adjusting the tracking and camber of rearward ground engaging wheels 34.

An electrically powered motor 95 similar to the electrically powered motors 32 of the rearward suspension arms 27 is secured to each one of the forward suspension arm 88 adjacent the second end 29 thereof. Each electrically powered motor 95 carries the corresponding one of the forward ground engaging wheels 87 in an identical manner as the electrically powered motors 32 carry the corresponding rearward ground engaging wheels 34, namely, with each electrically powered motor 95 located substantially within the well 52 of the wheel rim 50 of the corresponding forward ground engaging wheel 87. The electrically powered motors 95 are powered by the large rechargeable battery (not shown) and are controlled by the electrical and electronic control circuitry (also not shown) which controls the electrically powered motors 32, so that all four electrically powered motors 32 and 95 are synchronously controlled. As discussed above, the control circuitry is controlled from the cab 9 by the driver of the wheeled work vehicle 1.

Turning now to the pivotal coupling of the forward and rearward parts 3 and 5 of the work vehicle 1 about the vertically extending primary pivot axis 7, a pair of vertically aligned primary pivot shafts, namely, an upper primary pivot shaft 94 and a lower primary pivot shaft 96 defining the primary pivot axis 7 pivotally connect the forward and rearward parts 3 and 5 together, see FIG. 19. The upper primary pivot shaft 94 is pivotally engaged in a pair of upper rearward pivot brackets 97 extending forwardly from the super structure framework 17 of the rearward part 5 of the work vehicle. The lower primary pivot shaft 96 is pivotally engaged in a pair of lower rearward pivot brackets 98 extending forwardly from the super structure framework 17 of the rearward part 5 of the work vehicle. Corresponding upper and lower forward pivot brackets 99 and 100 extending rearwardly from the corresponding super structure framework, only a rearward portion 101 of which is shown in FIG. 19, of the forward part 3 of the work vehicle pivotally engage the upper and lower primary pivot shafts 94 and 96, respectively, between the respective pairs of the upper and lower rearward pivot brackets 97 and 98 for pivoting of the forward and rearward parts 3 and 5 of the work vehicle 1 relative to each other for steering of the work vehicle 1. Hydraulic rams (not shown) are located on each side of the upper and lower primary pivot shafts 94 and 96 extending between and operatively connected to the forward and rearward parts 3 and 5 of the work vehicle 1 for pivoting the forward and rearward parts 3 and 5 relative to each other about the primary pivot axis 7 for steering of the work vehicle 1, as will be understood by those skilled in the art.

In use, the forward and rearward parts 3 and 5 of the wheeled work vehicle 1 are separately assembled, as will be understood by those skilled in the art, and are then pivotally connected together by engaging the upper and lower primary pivot shafts 94 and 96 in the upper rearward pivot brackets 97 and the upper forward pivot bracket 99, and the lower rearward pivot brackets 98 and the lower forward pivot bracket 100, respectively. During assembly of the rearward and forward suspension arms 27 and 88, the electrically powered motors 32 are secured to the rearward suspension arms 27, as already described, and the electrically powered motors 95 are secured to the front suspension arms 88, as also already described. The rearward ground engaging wheels 34 and the forward ground engaging wheels 87, complete with the wheel rims 50 and the types 53 thereof are secured to the coupling plates 47 of the rearward and forward electrically powered motors 32 and 95 by the studs 49.

With the wheeled work vehicle 1 fully assembled and the forward and rearward parts 3 and 5 pivotally coupled together by the upper and lower primary pivot shafts 96 and 97, the tracking of the rearward and forward ground engaging wheels 34 and 87 is carried out. Initially, during assembly of the rearward and forward suspension arms 27 and 88 to the inner and outer mounting brackets 58 and 59 and 90 and 91, respectively, the adjustment elements 70a are located in the secondary bores 60 of the inner and outer mounting brackets 58 and 59 and 90 and 91. If the tracking or camber in any of the ground engaging wheels 34 and/or 87 is incorrect, the tracking and/or camber of that ground engaging wheel is adjusted by selecting the appropriate one of the adjustment elements 70b to 70d and replacing the adjustment element 70a in the relevant one of the outer mounting bracket 59 or 91 with the selected one of the adjustment element 70b to 70d. The selected one of the adjustment elements 70b to 70d is inserted in the secondary bore 60 of the corresponding one of the outer mounting bracket 59 or 91 in the appropriate orientation thereof, so that the engagement bore central axis 82 of the selected one of the adjustment elements 70b to 70d is offset in the appropriate direction (forward, rearward, upwardly or downwardly) from the engagement member central axis 81 thereof, as already described.

If greater adjustment of the tracking and/or the camber is required than can be achieved by the pair of adjustment elements 70a and 70d, the adjustment element 70a in the secondary bore 60 of the corresponding inner mounting bracket 58 or 90 is removed and replaced with a suitable selected one of the adjustment elements 70b to 70d, as already described. The selected ones of the adjustment elements 70b to 70d are inserted in the secondary bores of the corresponding inner and outer mounting brackets 58 and 59 or 90 and 91 appropriately orientated with the engagement bore central axes 82 of the respective selected adjustment elements 70b to 70d offset in the appropriate directions relative to the corresponding engagement member central axes 81, as already described.

With the tracking and/or camber of the rearward ground engaging wheels 34 and the forward ground engaging wheels 87 of the wheeled work vehicle 1 adjusted appropriately, the wheeled work vehicle is ready for use.

During subsequent servicing of the wheeled work vehicle 1, should the tracking and/or camber of the ground engaging wheels of the wheeled work vehicle require adjustment, adjustment of the tracking is carried out in a similar manner.

While the adjustment elements have been described as being of a specific shape, the adjustment elements may be of any suitable shape, and in general, will be of shape suitable for keying the engagement members of the adjustment elements in the secondary bores of the inner and outer mounting brackets or the main bore of the pivot mounting members of the suspension arms in at least two orientations at 180° relative to each other, but preferably, in four orientations at 90° relative to each other. Typically, the shape of the engagement member of each adjustment element will be such as to correspond to the shape of the secondary bore in the inner and outer mounting brackets or the main bore of the pivot mounting member of the suspension arms for keying the adjustment elements therein. Needless to say, the secondary bores through the rearward inner and outer mounting brackets 58 and 59 and the forward inner and outer mounting brackets 90 and 91 will be of similar shape and cross-sectional area in order to standardise on the shape of the engagement members 74 of the adjustment elements 70. It is also envisaged that the keying means for keying the adjustment elements 70 in the secondary bores of the inner and outer mounting brackets 58 and 59 and 90 and 91 may be provided by one or more keying slots extending into the mounting brackets from the secondary bores 60 engageable with a complementary keying member extending from the engagement member of the adjustment elements 70, or vice versa.

It will also be appreciated that while both the rearward part and the forward part of the work vehicle have been described as comprising rearward and forward suspension arms 27 and 88 for carrying the rearward and forward ground engaging wheels 34 and 87, in some embodiment of the invention it is envisaged that only either the rearward part 3 or the forward part 5 of the work vehicle would be provided with the ground engaging wheels carried on suspension arms. In which case, the ground engaging wheels of the other one of the rearward and forward parts of the work vehicle would be mounted by other suitable suspension means on the chassis. It is also envisaged that in some embodiments of the invention only either the rearward ground engaging wheels or the forward ground engaging wheels of the work vehicle would be powered, and in which case, the powered ground engaging wheels would be powered by the corresponding one of the electric motors 32 or 95, as the case may be.

While the adjustment elements have been described as being engageable with the secondary bores in the inner and outer mounting brackets, it is envisaged in some embodiments of the invention that the adjustment elements instead of being engageable with the secondary bores in the inner and outer mounting brackets, the adjustment elements would be engageable with one or both ends of the main bore extending through the pivot mounting member of the corresponding one of the rearward or forward suspension arm. In which case, the inner and outer mounting brackets would be provided with a suitable secondary bore engageable directly with the corresponding pivot shaft, and the pivot shaft may or may not be pivotal in the secondary bores of the inner and outer mounting brackets, and if the pivot shaft is not pivotal in the secondary bores of the corresponding inner and outer mounting brackets, the pivot shaft engagement bore of the respective adjustment elements would be pivotally engageable with the pivot shaft.

It is also envisaged that the range of offsets of the engagement bore central axis from the engagement member central axis of the adjustment elements may be greater than or less than 3 mm. It will also be appreciated that the incremental increase in the offset between the engagement bore central axis 82 and the engagement member central axis 81 of the adjustment elements may be any incremental amount, which may be as low as 0.25 mm and possibly lower, and up to 2 mm, and possibly greater, depending on the fineness of adjustment of the tracking and camber of the ground engaging wheels. It is also envisaged that in some embodiments of the invention separate adjustment elements may be provided for adjusting the camber from those for adjusting the tracking, and the range of offsets and the incremental distance between the offsets from one adjustment element to the next, may be different for adjustment elements for adjusting the camber to the ranges and incremental distances of the adjustment elements for adjusting the tracking.

While the forward and rearward suspension arms have been described as extending rearwardly from the corresponding one of the forward and rearward main transverse pivot axes, in some embodiments of the invention it is envisaged that one or both of the pairs of forward and rearward suspension arms may extend forwardly from the corresponding forward and rearward main transverse pivot axes. Indeed, in some embodiments of the invention it is envisaged that the forward suspension arms may extend forwardly from the corresponding one of the forward main transverse pivot axes while the rearward suspension arms may extend rearwardly from the corresponding one of the rearward main transverse pivot axes, or vice versa, where the forward suspension arms would extend rearwardly from the corresponding one of the forward main transverse pivot axes, and the rearward suspension arms would extend forwardly from the corresponding one of the rearward main transverse pivot axes.

It is also envisaged that in some embodiments of the invention instead of providing inner and outer mounting brackets for mounting each suspension arm on the chassis, only a single mounting bracket may be provided, which may be provided either on the inner side or the outer side of the corresponding suspension arm. In which case, it is envisaged that either one of the adjustment elements or a pair of the adjustment elements would be located in the main bore of the pivot mounting member of the corresponding suspension arm. If a pair of the adjustment elements were located in the main bore of the pivot mounting member, the adjustment elements would be located spaced apart from each other, and preferably, would be located at the respective opposite ends of the main bore. If only one adjustment element were located in the main bore of the corresponding pivot mounting member, that adjustment element would be engaged in the end of the main bore remote from the single mounting bracket. In generally, it is envisaged that if only one single mounting bracket were provided, the pivot shaft 62 would be rigidly secured to the mounting bracket, for example, by welding.

While the work vehicle has been described as comprising a forward part and rearward part which are pivotally coupled together, in some embodiments of the invention it is envisaged that the work vehicle may be provided with the forward and rearward parts fixed relative to each other and in which case the work vehicle would be provided with a simple integral chassis.

While the wheeled work vehicle according to the invention has been described as a road sweeping vehicle, it will be readily apparent to those skilled in the art that the wheeled work vehicle according to the invention may be adapted for any purpose, for example, snow clearing, as a towing vehicle, earth moving, whereby the forward part of the wheeled work vehicle would be configured to receive a forwardly facing plough blade, or a digger bucket mounted on a dipper arm.

It is envisaged that in some embodiments of the invention the speed at which the ground engaging wheels will be driven will match the speed at which drive is generated by the electric motors, although in general it is envisaged that a reduction gear train or a step-up gear train may be located within the housing of the electric motor to step-down or step-up as the case may be, the drive to the coupling element of the corresponding electric motor.

While the coupling element of each electric motor has been described as comprising five wheel engaging studs, any suitable number of wheel engaging studs or threaded bores for engaging wheel studs may be provided on each coupling element.

It is also envisaged that the electric motors may be mounted on a spacer mounted onto the corresponding suspension arm which would space the motor away and outwardly from the corresponding suspension arm. It is also envisaged that each motor may be recessed into the corresponding suspension arm, and in some embodiments of the invention may be configured to extend through a corresponding opening in the suspension arm. In which case, the mounting plate for mounting the motor to the suspension arm would be located intermediate the respective opposite ends of the housing of the electric motor. It is also envisaged in some embodiments of the invention that where a spacer is located between the motor and the corresponding suspension arm, the electric motor may be recessed into the spacer.

It will also be appreciated that in some embodiments of the invention instead of terminating the first end of each suspension arm in an elongated tubular pivot mounting member, in some embodiments of the invention a pair of spaced apart pivot mounting members may extend from the first end of the corresponding suspension arm, and each pivot mounting member would carry a corresponding bush for engaging the pivot shaft 62. Needless to say, any other suitable pivot mounting arrangement from pivotally mounting the first end of each suspension arm to the chassis may be provided.

While in the embodiment of the work vehicle described with reference to the drawings, the work vehicle has been provided with electric motors in each of the ground engaging wheels, and the suspension arms have been described coupled to the chassis with the adjustment elements, in some embodiments of the invention it is envisaged that only one or two of the ground engaging wheels would be powered by the electric motors, and in some embodiments of the invention it is envisaged that only the rearward suspension arms or the forward suspension arms would be provided with the adjustment elements, and typically, the forward suspension arms would be provided with the adjustment elements. Furthermore, it is envisaged that in some embodiments of the invention the work vehicle may be provided without any adjustment elements, and in other embodiments of the invention it is envisaged that the work vehicle may be provided without the drive means for the wheels being provided by the electric motors recessed into the wells of the wheel rims of the ground engaging wheels.

It is also envisaged that in some embodiments of the invention the wheeled work vehicle, whether it be a two-part wheeled work vehicle, or a single-part wheeled work vehicle, the wheeled work vehicle may be powered by means other than electrically powered motors mounted on the suspension arms, for example, the wheeled work vehicle may be powered by hydraulic motors mounted on the suspension arms.

It is also envisaged that in some embodiments of the invention where tracking and/or camber of the wheel is correct, the adjustment elements used in those cases typically would be the adjustment elements 70a where the engagement member central axis and the engagement bore central axis coincide. Needless to say, in such cases, a corresponding pair of the adjustment elements 70b would be provided or a corresponding pair of the adjustment elements 70c, or a corresponding pair of the adjustment elements 70d, and in each case the engagement bore central axes of the pair would be axially aligned. It will also be appreciated that any combination of the adjustment elements 70a to 70d may be used in the coupling of each suspension arm to the chassis. The combinations may be such that one of the adjustment elements may have the engagement bore central axis offset forwardly or rearwardly from the engagement member central axis, and the other one of the adjustment elements may have the engagement bore central axis offset upwardly or downwardly relative to the engagement member central axis, depending on the nature of the tracking and/or the camber of the wheel to be corrected.

Needless to say, during servicing of a wheeled work vehicle, if the tracking or the camber due to wear were incorrect, the adjustment of the tracking and/or the camber could be carried out by appropriately selecting one or a pair of the adjustment elements.

1-115. (canceled)

116. A wheeled work vehicle comprising a chassis supported on a pair of spaced apart forward ground engaging wheels and a pair of spaced apart rearward ground engaging wheels with the rearward ground engaging wheels spaced apart rearwardly from the forward ground engaging wheels, at least the pair of the forward ground engaging wheels or the pair of the rearward ground engaging wheels being carried on respective suspension arms, each suspension arm extending from a first end to a second end, and being pivotally coupled adjacent the first end thereof to the chassis about a corresponding main transverse pivot axis extending substantially transversely relative to the normal forward direction of travel of the work vehicle, and carrying a corresponding electrically powered motor adjacent the second end thereof for driving the corresponding ground engaging wheel, each motor defining a rotational drive axis about which drive is delivered by the motor and extending sidewardly outwardly from the corresponding suspension arm with the drive axis of the motor extending transversely relative to the normal forward direction of travel of the work vehicle, and each motor defining an outer transverse cross-sectional area transversely of the drive axis thereof less than the transverse cross-sectional area of the well of a wheel rim of the corresponding ground engaging wheel, so that the motor fits substantially within the well of the wheel rim of the corresponding ground engaging wheel.

117. A wheeled work vehicle as claimed in claim 116 in which each motor comprises a housing defining the outer transverse cross-sectional area of the motor secured to the corresponding suspension arm, and a coupling element rotatable in the housing and rotatably driven by the motor about the drive axis thereof, the coupling element being adapted for releasable coupling of the wheel rim of the corresponding ground engaging wheel thereto, and preferably, the coupling element of each motor is rotatably mounted in the housing thereof, and is driven by components of the motor located in the housing of the motor.

118. A wheeled work vehicle as claimed in claim 117 in which each motor comprises a drive means rotatably mounted in the housing thereof about the drive axis, the drive means being driven by the motor, and the coupling element is mounted fast on the drive means and is driven by the drive means, and preferably, a braking system is located within the housing of each motor cooperable directly or indirectly with the drive means or the coupling element for braking thereof, and preferably, the braking system cooperates with the drive means for braking thereof, and advantageously, the braking system comprises a dynamic braking means for slowing the rotational speed delivered by the drive means of the motor, and preferably, the braking system comprises a parking braking means for preventing rotation of the drive means, and advantageously, the dynamic braking means comprises the parking braking means, and preferably, the dynamic braking means comprises a shoe brake, and advantageously, the shoe brake comprises a pair of brake shoes acting on a drum mounted fast on the drive means, and preferably, the brake shoes act on an inner surface of the drum, and advantageously, a speed reduction means or a speed increasing means is located within the housing of each motor to reduce or increase the speed of the drive from the drive means to the coupling element of the corresponding electric motor, and preferably, the speed reduction means comprises a speed reduction gear train, and advantageously, the speed increasing means comprises a step-up gear train.

119. A wheeled work vehicle as claimed in claim 117 in which the housing of each motor is of length along its drive axis so that the motor fits substantially entirely within the well of the wheel rim of the corresponding ground engaging wheel or a portion of the motor extends axially outwardly of the well of the wheel rim of the corresponding ground engaging wheel, and preferably, the housing of each motor defines a securing location at which the housing is adapted for securing to the corresponding suspension arm, the securing location defined by the housing being axially spaced apart from the coupling element, and advantageously, the spacing between the securing location defined by the housing of each motor and the coupling element thereof is substantially equal to or greater than the depth of the well of the wheel rim of the corresponding ground engaging wheel, and preferably, a mounting element is located on the housing of each motor adjacent the securing location for securing the housing of the motor to the corresponding suspension arm, and advantageously, the coupling element of each motor comprises a central coupling plate, and preferably, the coupling element carries at least three threaded studs, or is provided with at least three threaded bores, the threaded studs or the threaded bores being equi-spaced apart angularly about the drive axis defined by the motor, and advantageously, the suspension arms of the rearward ground engaging wheels or the forward ground engaging wheels extends generally rearwardly from the corresponding main transverse pivot axis about which the suspension arm is pivotally coupled to the chassis.

120. A wheeled work vehicle as claimed in claim 116 in which the suspension arms of the forward ground engaging wheels are pivotal independently of each other about the respective main transverse pivot axes thereof about which the suspension arms are pivotally coupled to the chassis, and/or the suspension arms of the rearward ground engaging wheels are pivotal independently of each other about the respective main transverse pivot axes thereof about which the suspension arms are pivotally coupled to the chassis, and each suspension arm adjacent the first end thereof terminates in a pivot mounting member defining a main bore extending therethrough cooperable with a corresponding pivot shaft coupled to the chassis, the pivot shaft defining the corresponding main transverse pivot axis about which the suspension arm is pivotal, and being carried on at least one mounting bracket mounted on the chassis, each mounting bracket defines a secondary bore extending therethrough for accommodating the corresponding pivot shaft therein, the secondary bore of at least one of the mounting brackets of the corresponding suspension arm, or the main bore extending through the pivot mounting member of the corresponding suspension arm is adapted for engaging one of a plurality of selectable adjustment elements, each adjustment element comprising an engagement member for engaging the corresponding one of the secondary bore of the at least one of the mounting brackets or the main bore in the pivot mounting member, the engagement member defining an engagement member central axis, and having an engagement bore extending therethrough for engaging the pivot shaft of the corresponding pivot mounting member, the engagement bore of each adjustment element defining an engagement bore central axis, the engagement bore central axis of each adjustment element defining the main transverse pivot axis about which the corresponding suspension arm is pivotal when the engagement member of the adjustment element is engaged in the secondary bore of the corresponding one of the mounting brackets, or the main bore of the pivot mounting member.

121. A wheeled work vehicle as claimed in claim 120 in which the pivot shaft of each suspension arm is carried on a corresponding pair of the mounting brackets spaced apart transversely from each other, with the corresponding pivot shaft extending between the two mounting brackets, and preferably, the pivot mounting member of each suspension arm is located between the corresponding pair of the mounting brackets.

122. A wheeled work vehicle as claimed in claim 121 in which the engagement bore central axis of each adjustment element extends substantially parallel to the engagement member central axis of the engagement member thereof, and preferably, the engagement bore central axis coincides with the engagement member central axis of at least one of the adjustment elements adjacent the engagement bore thereof of the plurality of the adjustment elements, and advantageously, the spacings between the engagement bore central axis and the engagement member central axis of two of the adjustment elements adjacent the engagement bore thereof are substantially identical to each other, and preferably, the spacing between the engagement bore central axis and the engagement member central axis of at least one of the adjustment elements adjacent the engagement bore thereof is different to the spacing between the engagement bore central axis and the engagement member central axis of other ones of the adjustment elements adjacent the engagement bore thereof for adjusting one or both of the tracking (toe-in/toe-out) or the camber of the corresponding one of the ground engaging wheels, and preferably, the spacings between the engagement bore central axis and the engagement member central axis of a plurality of the adjustment elements adjacent the engagement bores thereof progressively increase from one of the adjustment elements in which the engagement bore central axis coincides with or is closest to the engagement member central axis adjacent the engagement bore thereof to the adjustment element in which the spacing between the engagement bore central axis and the engagement member central axis adjacent the engagement bore thereof is greatest, and advantageously, the spacings between the engagement bore central axis and the engagement member central axis of the plurality of the adjustment elements adjacent the engagement bore thereof progressively increase from one of the adjustment elements to the next one of the adjustment elements by a predefined incremental amount, and preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.25 mm to 3.00 mm, and advantageously, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.5 mm to 2 mm, and preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.75 mm to 1.5 mm, and advantageously, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.9 mm to 1.25 mm, and preferably, the predefined incremental amount, by which the spacing between the engagement bore central axis and the engagement member central axis of the plurality of the adjustment elements progressively increase from one of the adjustment elements to the next one of the adjustment elements is approximately 1 mm.

123. A wheeled work vehicle as claimed in claim 122 in which a keying means is provided for keying the adjustment elements relative to the secondary bore of each of the mounting brackets or the main bore extending through each of the pivot mounting members with the direction of the spacing of the engagement bore central axis from the engagement member central axis of the adjustment element adjacent the engagement bore thereof extending in at least one selectable predefined direction relative to the normal forward direction of travel of the work vehicle when inserted in the secondary bore of one of the mounting brackets or the main bore of one of the pivot mounting members, and preferably, one of the predefined directions comprises a forward direction relative to the normal forward direction of travel of the work vehicle to adjust the tracking of the corresponding one of the ground engaging wheels of the work vehicle, and advantageously, one of the predefined directions comprises a rearward direction relative to the normal forward direction of travel of the work vehicle to adjust the tracking of the corresponding one of the ground engaging wheels of the work vehicle, and preferably, one of the predefined directions comprises an upward direction relative to the normal forward direction of travel of the work vehicle to adjust the camber of the corresponding one of the ground engaging wheels of the work vehicle, and advantageously, one of the predefined directions comprises a downward direction relative to the normal forward direction of travel of the work vehicle to adjust the camber of the corresponding one of the ground engaging wheels of the work vehicle, and preferably, the keying means is configured to permit the engagement member of the adjustment elements to engage the secondary bore of the mounting brackets or the main bore of the pivot mounting members in at least one selectable predefined orientation with the direction of the spacing of the engagement bore central axis from the engagement member central axis adjacent the engagement bore thereof extending in at least a corresponding one of the predefined directions, and advantageously, the keying means is configured to permit the engagement member of the adjustment elements to engage the secondary bore of the mounting brackets or the main bore of the pivot mounting members in at least two selectable predefined orientations with the direction of the spacing of the engagement bore central axis from the engagement member central axis adjacent the engagement bore thereof extending in at least two of the corresponding predefined directions, and preferably, the keying means is configured to permit the engagement member of the adjustment elements to engage the secondary bore of the mounting brackets or the main bore of the pivot mounting members in at least three selectable predefined orientations with the direction of the spacing of the engagement bore central axis from the engagement member central axis adjacent the engagement bore thereof extending in at least three of the corresponding predefined directions, and advantageously, the keying means is configured to permit the engagement member of the adjustment elements to engage the secondary bore of the mounting brackets or the main bore of the pivot mounting members in four selectable predefined orientations with the direction of the spacing of the engagement bore central axis from the engagement member central axis adjacent the engagement bore thereof extending in the four corresponding predefined directions, and preferably, the keying means comprises providing the outer periphery of the engagement member of the adjustment elements to engage the secondary bore of the mounting brackets or the main bore of the pivot mounting members, and advantageously, the keying means is provided by providing the outer periphery of the engagement member of the adjustment elements to be complementary to the secondary bore of the mounting brackets or the main bore of the pivot mounting members, and preferably, the outer periphery of the engagement member of the adjustment elements is of substantially square shape, and advantageously, the engagement member of each one of the plurality of the adjustment elements is engageable with the secondary bore defined by the mounting brackets, and preferably, the adjustment elements comprise an indicating means to indicate the direction of the spacing of the engagement bore central axis from the engagement member central axis, and preferably, the indicating means is configured to indicate the amount by which the engagement bore central axis is spaced apart from the engagement member central axis.

124. A wheeled work vehicle as claimed in claim 116 in which the forward ground engaging wheels are carried on respective ones of the suspension arms, and preferably, the rearward ground engaging wheels are carried on respective ones of the suspension arms, and advantageously, the forward ground engaging wheels and the rearward ground engaging wheels are carried on respective ones of the suspension arms, and preferably, the chassis comprises a forward chassis, and a rearward chassis pivotally coupled to the forward chassis about a generally upwardly extending primary pivot axis about which the work vehicle is steerable, and preferably, the forward chassis is supported on the pair of spaced apart forward ground engaging wheels, and the rearward chassis is supported on the pair of spaced apart rearward ground engaging wheels, and advantageously, the suspension arm of each one of the forward ground engaging wheels is pivotally connected to the forward chassis about the corresponding main transverse pivot axis, and preferably, the suspension arm of each one of the forward ground engaging wheels is pivotally connected to the forward chassis about the corresponding main transverse pivot axis by at least a corresponding one of the mounting brackets mounted on the forward chassis, and advantageously, the suspension arm of each one of the rearward ground engaging wheels is pivotally connected to the rearward chassis about the corresponding main transverse pivot axis, and preferably, the suspension arm of each one of the rearward ground engaging wheels is pivotally connected to the rearward chassis about the corresponding main transverse pivot axis by at least a corresponding one of the mounting brackets mounted on the rearward chassis.

125. A wheeled work vehicle comprising a chassis supported on a pair of spaced apart forward ground engaging wheels and a pair of spaced apart rearward ground engaging wheels with the rearward ground engaging wheels spaced apart rearwardly from the forward ground engaging wheels, at least either the pair of the forward ground engaging wheels or the pair of the rearward ground engaging wheels being carried on respective suspension arms, each suspension arm extending from a first end to a second end, and carrying the corresponding ground engaging wheel adjacent the second end thereof, the first end of each suspension arm being pivotally coupled to the chassis about a corresponding main transverse pivot axis extending substantially transversely of the normal forward direction of travel of the work vehicle, the first end of each suspension arm terminating in a pivot mounting member defining a main bore extending therethrough for accommodating a pivot shaft therethrough defining the corresponding main transverse pivot axis about which the suspension arm is pivotal, the pivot shaft being carried on at least one mounting bracket mounted on the chassis, the at least one mounting bracket defining a secondary bore extending therethrough, and a plurality of selectable adjustment elements, each adjustment element comprising an engagement member engageable with the secondary bore of the at least one mounting bracket or the main bore of the pivot mounting member and defining an engagement member central axis, and having an engagement bore extending therethrough engageable with the pivot shaft of the corresponding suspension arm and defining an engagement bore central axis, the engagement bore central axis defining the main transverse pivot axis about which the corresponding suspension arm is pivotal, the spacing between the engagement bore central axis and the engagement member central axis adjacent the engagement bore thereof of at least one of the adjustment elements being different to the spacing between the engagement bore central axis and the engagement member central axis adjacent the engagement bore thereof of other ones of the adjustment elements for adjusting one or both of the tracking (toe in/toe out) or the camber of the corresponding ground engaging wheel.

126. A wheeled work vehicle as claimed in claim 125 in which a pair of spaced apart mounting brackets corresponding to each suspension arm mounted on the chassis, and the pivot mounting member of the corresponding suspension arm is located between the pair of the mounting brackets, and preferably, the engagement bore central axis of each adjustment element extends substantially parallel to the engagement member central axis of the engagement member thereof.

127. A wheeled work vehicle as claimed in claim 125 in which the engagement bore central axis coincides with the engagement member central axis of at least one of the adjustment elements adjacent the engagement bore thereof of the plurality of the adjustment elements, and preferably, the spacings between the engagement bore central axis and the engagement member central axis of two of the adjustment elements adjacent the engagement bore thereof are substantially identical to each other.

128. A wheeled work vehicle as claimed in claim 125 in which the spacings between the engagement bore central axis and the engagement member central axis of a plurality of the adjustment elements adjacent the engagement bores thereof progressively increase from one of the adjustment elements in which the engagement bore central axis coincides with or is closest to the engagement member central axis adjacent the engagement bore thereof to the adjustment element in which the spacing between the engagement bore central axis and the engagement member central axis adjacent the engagement bore thereof is greatest, and preferably, the spacings between the engagement bore central axis and the engagement member central axis of the plurality of the adjustment elements adjacent the engagement bore thereof progressively increase from one of the adjustment elements to the next one of the adjustment elements by a predefined incremental amount, and advantageously, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.25 mm to 3.00 mm, and preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.5 mm to 2 mm, and advantageously, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.75 mm to 1.5 mm, and preferably, the predefined incremental amount, by which the spacings between the engagement bore central axis and the engagement member central axis of the plurality of the adjustment elements adjacent the engagement bore thereof progressively increase from one of the adjustment elements to the next one of the adjustment elements, lies in the range of 0.9 mm to 1.25 mm, and advantageously, the predefined incremental amount, by which the spacing between the engagement bore central axis and the engagement member central axis of the plurality of the adjustment elements progressively increase from one of the adjustment elements to the next one of the adjustment elements is approximately 1 mm.

129. A wheeled work vehicle as claimed in claim 125 in which a keying means is provided for keying the adjustment elements relative to the secondary bore of each of the mounting brackets or the main bore extending through each of the pivot mounting members with the direction of the spacing of the engagement bore central axis from the engagement member central axis of the adjustment element adjacent the engagement bore thereof extending in at least one selectable predefined direction relative to the normal forward direction of travel of the work vehicle when inserted in the secondary bore of one of the mounting brackets or the main bore of one of the pivot mounting members, and preferably, one of the predefined directions comprises a forward direction relative to the normal forward direction of travel of the work vehicle to adjust the tracking of the corresponding one of the ground engaging wheels of the work vehicle, and advantageously, one of the predefined directions comprises a rearward direction relative to the normal forward direction of travel of the work vehicle to adjust the tracking of the corresponding one of the ground engaging wheels of the work vehicle, and preferably, one of the predefined directions comprises an upward direction relative to the normal forward direction of travel of the work vehicle to adjust the camber of the corresponding one of the ground engaging wheels of the work vehicle, and advantageously, one of the predefined directions comprises a downward direction relative to the normal forward direction of travel of the work vehicle to adjust the camber of the corresponding one of the ground engaging wheels of the work vehicle, and preferably, the keying means is configured to permit the engagement member of the adjustment elements to engage the secondary bore of the mounting brackets or the main bore of the pivot mounting members in at least one selectable orientation with the direction of the spacing of the engagement bore central axis from the engagement member central axis adjacent the engagement bore thereof extending in at least a corresponding one of the predefined directions, and advantageously, the keying means is configured to permit the engagement member of the adjustment elements to engage the secondary bore of the mounting brackets or the main bore of the pivot mounting members in at least two selectable orientations with the direction of the spacing of the engagement bore central axis from the engagement member central axis adjacent the engagement bore thereof extending in at least two of the corresponding predefined directions, and preferably, the keying means is configured to permit the engagement member of the adjustment elements to engage the secondary bore of the mounting brackets or the main bore of the pivot mounting members in at least three selectable orientations with the direction of the spacing of the engagement bore central axis from the engagement member central axis adjacent the engagement bore thereof extending in at least three of the corresponding predefined directions, and advantageously, the keying means is configured to permit the engagement member of the adjustment elements to engage the secondary bore of the mounting brackets or the main bore of the pivot mounting members in four selectable orientations with the direction of the spacing of the engagement bore central axis from the engagement member central axis adjacent the engagement bore thereof extending in the four corresponding predefined directions, and preferably, the keying means comprises providing the outer periphery of the engagement member of the adjustment elements to engage the secondary bore of the mounting brackets or the main bore of the pivot mounting members, and advantageously, the keying means is provided by providing the outer periphery of the engagement member of the adjustment elements to be complementary to the secondary bore of the mounting brackets or the main bore of the pivot mounting members, and preferably, the outer periphery of the engagement member of the adjustment elements is of substantially square shape, and advantageously, the engagement member of each one of the plurality of the adjustment elements is engageable with the secondary bore defined by the mounting brackets.

130. A wheeled work vehicle as claimed in claim 125 in which the adjustment elements comprise an indicating means to indicate the direction of the spacing of the engagement bore central axis from the engagement member central axis, and preferably, the indicating means is configured to indicate the amount by which the engagement bore central axis is spaced apart from the engagement member central axis.

131. A wheeled work vehicle as claimed in claim 125 in which the mounting brackets of each pair thereof comprise respective ones of the adjustment elements located in the secondary bores thereof, or the main bore defined by the pivot mounting member of each suspension arm comprises a pair of the adjustment elements located spaced apart therein, the orientation of the adjustment elements in the secondary bores of the pair of the mounting brackets, or the orientation of the adjustment elements in the main bore of the pivot mounting member being the same or different, and preferably, the spacings between the engagement bore central axis and the engagement member central axis of the adjustment elements in the secondary bores of the mounting brackets of each pair thereof, or in the main bore of the pivot mounting member are the same or different.

132. A wheeled work vehicle as claimed in claim 125 in which the forward ground engaging wheels are carried on respective ones of the suspension arms, and preferably, the rearward ground engaging wheels are carried on respective ones of the suspension arms, and advantageously, the forward ground engaging wheels and the rearward ground engaging wheels are carried on respective ones of the suspension arms, and preferably, the chassis comprises a two-part chassis comprising a forward chassis and a rearward chassis, the forward chassis and the rearward chassis being pivotally coupled about a primary pivot axis for steering of the work vehicle, and advantageously, the forward chassis is supported on the pair of spaced apart forward ground engaging wheels, and the rearward chassis is supported on the pair of spaced apart rearward ground engaging wheels, and preferably, the suspension arm of each one of the forward ground engaging wheels is pivotally connected to the forward chassis about the corresponding main transverse pivot axis, and advantageously, the suspension arm of each one of the forward ground engaging wheels is pivotally connected to the forward chassis about the corresponding main transverse pivot axis by at least a corresponding one of the mounting brackets mounted on the forward chassis, and preferably, the suspension arm of each one of the rearward ground engaging wheels is pivotally connected to the rearward chassis about the corresponding main transverse pivot axis, and advantageously, the suspension arm of each one of the rearward ground engaging wheels is pivotally connected to the rearward chassis about the corresponding main transverse pivot axis by at least a corresponding one of the mounting brackets mounted on the rearward chassis.

133. A method for adjusting one or both of the tracking (toe in/toe out) and the camber of a ground engaging wheel of a wheeled work vehicle, wherein the wheeled work vehicle comprises a chassis, at least one ground engaging wheel carried on a suspension arm, the suspension arm extending from a first end to a second end and carrying the ground engaging wheel adjacent the second end thereof, the first end of the suspension arm being pivotally coupled to the chassis about a main transverse pivot axis extending transversally of the normal forward direction of travel of the work vehicle, the first end of the suspension arm having a main bore extending therethrough for accommodating a pivot shaft extending therethrough, the pivot shaft defining the main transverse pivot axis, at least one mounting bracket mounted on the chassis and defining a secondary bore extending therethrough for accommodating the pivot shaft therein, the method comprising providing a plurality of selectable adjustment elements, each adjustment element comprising an engagement member defining an engagement member central axis and engageable in one of the secondary bore extending through the at least one mounting bracket or the main bore extending through the suspension arm, and having a pivot shaft engagement bore extending therethrough engageable with the pivot shaft and defining an engagement bore central axis, the spacing between the engagement bore pivot axis and the engagement member pivot axis adjacent the engagement bore thereof of at least one of the adjustment elements being different to the spacing between the engagement bore central axis and the engagement member central axis adjacent the engagement bore thereof of the other ones of the adjustment elements, selecting at least one of the adjustment elements, and engaging the engagement member of the selected adjustment element in either the secondary bore of the mounting bracket or the main bore of the suspension arm for adjusting one or both of the tracking or the camber of the corresponding ground engaging wheel.

134. A method as claimed in claim 133 in which the engagement bore central axis and the engagement member central axis extend substantially parallel to each other, and preferably, a pair of spaced apart mounting brackets are provided, with the first end of the suspension arm located therebetween, and advantageously, two of the adjustment elements are selected and engaged in the secondary bores of the respective mounting brackets, or are engaged spaced apart in the main bore of the suspension arm, and preferably, the spacings between the engagement bore central axis and the engagement member central axis adjacent the engagement bore thereof of each of the adjustment elements of the selected pair thereof for adjusting the tracking or the camber of the ground engaging wheel of the at least one of the suspension arms are substantially similar, and advantageously, the spacing between the engagement bore central axis and the engagement member central axis adjacent the engagement bore thereof of one of the adjustment elements of the selected pair thereof for adjusting the tracking or the camber of the ground engaging wheel of the at least one of the suspension arms is different to the spacing between the engagement bore central axis and the engagement member central axis adjacent the engagement bore thereof of the other one of the adjustment elements of the selected pair thereof, and preferably, the adjustment elements of the selected pair thereof are engaged in the secondary bores of the corresponding pair of the mounting brackets or in the main bore defined by the corresponding suspension arm with the orientation of the respective adjustment elements being the same or different.

135. An adjustment element for adjusting one or both of the tracking or the camber of a ground engaging wheel of a wheeled work vehicle as claimed in claim 125, and preferably, the adjustment element comprises an engagement member configured for engaging one of a secondary bore of a mounting bracket mounted on a chassis of a wheeled work vehicle, or a main bore of a pivot mounting member of a suspension arm carrying a ground engaging wheel, the engagement member of the adjustment element defining an engagement member central axis and having a pivot shaft engagement bore extending therethrough defining an engagement bore central axis, the engagement bore central axis coinciding with the engagement member central axis adjacent the engagement bore or being spaced apart from the engagement member central axis adjacent the engagement bore thereof, and advantageously, the adjustment element comprises a keying means for keying the adjustment element in the secondary bore of one of the mounting brackets or of the main bore of the pivot mounting member of the suspension arm in at least one orientation, and preferably, a plurality of the adjustment elements are provided, and the spacing between the engagement bore central axis and the engagement member central axis of the engagement member adjacent the pivot shaft engagement bore thereof in at least one of the adjustment elements is different to the spacing between the engagement bore central axis and the engagement member central axis adjacent the pivot shaft engagement bore of the engagement member of others of the adjustment elements.
